(19) United States
(12) Patent Application Publication
(10) Pub. No.: US 2025/0091340 A1
(43) Pub. Date: Mar. 20, 2025

(54) LIQUID EJECTION APPARATUS

(71) Applicant: BROTHER KOGYO KABUSHIKI KAISHA, Nagoya (JP)

(72) Inventors: Masahiro HAYASHI, Anjo (JP); Kenta HORADE, Tokai (JP); Zenichiro SASAKI, Nagoya (JP); Takafumi NAKASE, Nagoya (JP); Nobumasa TANAKA, Nagoya (JP); Ryuji HORATA, Gamagori (JP)

(21) Appl. No.: 18/885,972

(22) Filed: Sep. 16, 2024

(30) Foreign Application Priority Data
Sep. 19, 2023 (JP) 2023-151664

(51) Int. Cl. B41J 2/045; B41J 2/165

(52) U.S. Cl. CPC B41J 2/0451; B41J 2/04541; B41J 2/04581; B41J 2/1652; B41J 2/16579; B41J 2002/16573

(57) ABSTRACT

A controller of a liquid ejection apparatus controls an ejection inspection circuit to perform a first ejection inspection. After the first ejection inspection, the controller controls a driving element to perform a post-inspection driving operation including a plurality of types of driving operations. The plurality of types of driving operations have different driving frequencies for driving the driving element. After the post-inspection driving operation, the controller controls the ejection inspection circuit to perform a second ejection inspection. In a case where a first condition is satisfied regarding a relationship between a result of the first ejection inspection and a result of the second ejection inspection, the controller performs a first operation including the post-inspection driving operation after the second ejection inspection. In a case where the first condition is not satisfied, the controller performs a second operation different from the first operation after the second ejection inspection.

### REFERENCE TO RELATED APPLICATIONS

This application claims priority from Japanese Patent Application No. 2023-151664 filed on Sep. 19, 2023. The entire content of the priority application is incorporated herein by reference.

### BACKGROUND ART

As an example of a liquid ejection apparatus that ejects liquid from nozzles, an inkjet printer that performs recording by ejecting ink from nozzles is known.

### SUMMARY

In an inkjet printer, flushing for removing high-viscosity ink (thickened ink) in the vicinity of nozzles is performed, and ink in an ink channel is vibrated during a period in which the flushing is not performed, so that the thickened ink is efficiently removed.

In the printer, in order to efficiently reduce the viscosity increase (thickening) of the ink, in addition to the flushing, the ink in the ink channel is vibrated during a period in which the flushing is not performed. In a liquid ejection apparatus that ejects liquid from a nozzle, it is required to more efficiently reduce viscosity increase of liquid in a liquid channel.

In view of the foregoing, an example of an object of this disclosure is to provide a liquid ejection apparatus configured to more efficiently reduce viscosity increase of liquid in a liquid channel.

According to one aspect, this specification discloses a liquid ejection apparatus. The liquid ejection apparatus includes a head, an ejection inspection circuit, and a controller. The head includes a plurality of nozzles and a plurality of driving elements. The plurality of driving elements are configured to apply ejection energy to liquid in the plurality of nozzles. The ejection inspection circuit is configured to perform ejection inspection of inspecting whether each of the plurality of nozzles is an abnormal nozzle having abnormality in ejection of liquid. The controller is configured to control the ejection inspection circuit to perform a first ejection inspection. Thus, the liquid ejection apparatus performs the first ejection inspection. The controller is configured to, after the first ejection inspection, control a driving element to perform a post-inspection driving operation including a plurality of types of driving operations. The plurality of types of driving operations have different driving frequencies for driving the driving element. The plurality of driving elements include the driving element. Thus, the liquid ejection apparatus performs the post-inspection driving operation. The controller is configured to, after the post-inspection driving operation, control the ejection inspection circuit to perform a second ejection inspection. Thus, the liquid ejection apparatus performs the second ejection inspection. The controller is configured to, in a case where a first condition is satisfied regarding a relationship between a result of the first ejection inspection and a result of the second ejection inspection, perform a first operation after the second ejection inspection. The first operation includes the post-inspection driving operation. Thus, in a case where the first condition is satisfied, the liquid ejection apparatus performs the first operation including the post-inspection driving operation. The controller is configured to, in a case where the first condition is not satisfied, perform a second operation after the second ejection inspection. The second operation is different from the first operation. Thus, in a case where the first condition is not satisfied, the liquid ejection apparatus performs the second operation different from the first operation.

According to another aspect, the controller is configured to control the ejection inspection circuit to perform a first ejection inspection. The controller is configured to, after the first ejection inspection, perform a cleaning operation of discharging liquid from the abnormal nozzle. Thus, the liquid ejection apparatus performs the cleaning operation. The controller is configured to, after the cleaning operation, control the ejection inspection circuit to perform the second ejection inspection. The controller is configured to, in a case where a particular condition is satisfied regarding a relationship between a result of the first ejection inspection and a result of the second ejection inspection, perform a first operation after the second ejection inspection, the first operation including the cleaning operation. Thus, the liquid ejection apparatus performs the first operation including the cleaning operation. The controller is configured to, in a case where the particular condition is not satisfied, perform a second operation after the second ejection inspection, the second operation being different from the first operation. Thus, the liquid ejection apparatus performs the second operation different from the first operation.

In the present disclosure, the second ejection inspection is performed after the post-inspection driving operation or the cleaning operation is performed after the first ejection inspection. Then, in a case where the first condition for the relationship between the result of the first ejection inspection and the result of the second ejection inspection is satisfied, the first operation including the post-inspection driving operation or the cleaning operation is performed after the second ejection inspection. In a case where the first condition is not satisfied, the second operation different from the first operation is performed after the second ejection inspection. Accordingly, the viscosity increase of the liquid is efficiently suppressed depending on the results of the first and second ejection inspections. For example, in a case where an effect of suppressing viscosity increase by the post-inspection driving operation or the cleaning operation after the first ejection inspection is high, the first operation including the post-inspection driving operation or the cleaning operation is performed after the second ejection inspection, thereby further suppressing viscosity increase. For example, in a case where the effect of suppressing viscosity increase by the post-inspection driving operation or the cleaning operation after the first ejection inspection is low, the second operation different from the first operation is performed after the second ejection inspection, thereby not repeating the post-inspection driving operation or the cleaning operation having a low viscosity increase reduction effect. Here, the phrase “not repeating the post-inspection driving operation or the cleaning operation having a low viscosity increase reduction effect” means, for example, not performing the post-inspection driving operation or the cleaning operation or performing the post-inspection driving operation or the cleaning operation having a higher viscosity increase reduction effect.

### BRIEF DESCRIPTION OF DRAWINGS

FIG. 1 is a schematic configuration diagram of a printer.

FIG. 2 is a diagram for explaining an electrode disposed in a cap and a configuration for applying a voltage to the electrode.

FIG. 3A is a diagram for explaining a signal output from a signal processing circuit in a case where a nozzle is normal.

FIG. 3B is a diagram for explaining a signal output from the signal processing circuit in a case where the nozzle has an abnormality of an ejection amount.

FIG. 4 is a block diagram showing an electrical configuration of the printer.

FIG. 5A is a flowchart showing a flow of processing when performing an inspection of whether a nozzle is an abnormal nozzle.

FIG. 5B is a flowchart showing a flow of a post-inspection driving process of FIG. 5A.

FIG. 6 is a flowchart showing a flow of processing when performing an inspection of whether a nozzle is an abnormal nozzle.

FIG. 7A is a diagram for explaining a purge level.

FIG. 7B is a flowchart showing a flow of processing when performing an inspection of whether a nozzle is an abnormal nozzle.

FIG. 8A is a flowchart showing a flow of processing when performing an inspection of whether a nozzle is an abnormal nozzle.

FIG. 8B is a diagram for explaining a difference between a first post-inspection driving process and a second post-inspection driving process.

FIG. 9 is a flowchart showing a flow of processing when performing an inspection of whether a nozzle is an abnormal nozzle.

FIG. 10 is a flowchart showing a flow of processing when performing an inspection of whether a nozzle is an abnormal nozzle.

FIGS. 11A, 11B, 11C, 11D, 11E and 11F are diagrams for explaining a difference between a first post-inspection driving process and a second post-inspection driving process.

FIG. 12 is a flowchart showing a flow of processing when performing an inspection of whether a nozzle is an abnormal nozzle.

FIG. 13 is a flowchart showing a flow of processing when performing an inspection of whether a nozzle is an abnormal nozzle.

FIG. 14 is a flowchart showing a flow of processing when performing an inspection of whether a nozzle is an abnormal nozzle.

FIG. 15 is a flowchart showing a flow of processing when performing an inspection of whether a nozzle is an abnormal nozzle.

FIG. 16 is a flowchart showing a flow of processing performed when power is supplied to a printer.

FIG. 17 is a flowchart showing a flow of processing when performing an inspection of whether a nozzle is an abnormal nozzle.

### DESCRIPTION

Hereinafter, a first embodiment of the present disclosure will be described.

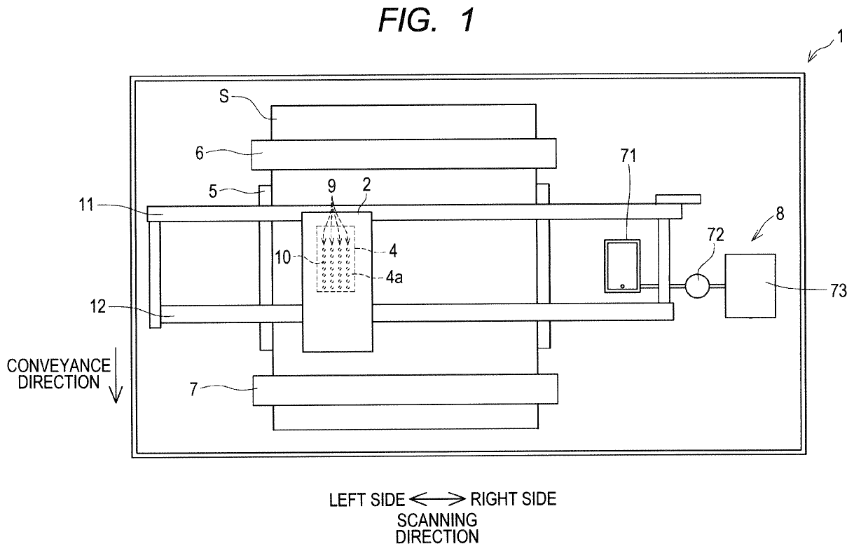

As shown in FIG. 1, a printer 1 according to the first embodiment includes a carriage 2, an inkjet head 4, a platen 5, conveyance rollers 6 and 7, a maintenance unit 8, and so on. In the first embodiment, the inkjet head 4 is an example of a “head” of the present disclosure. In the first embodiment, the maintenance unit 8 is an example of a “purge unit” of the present disclosure.

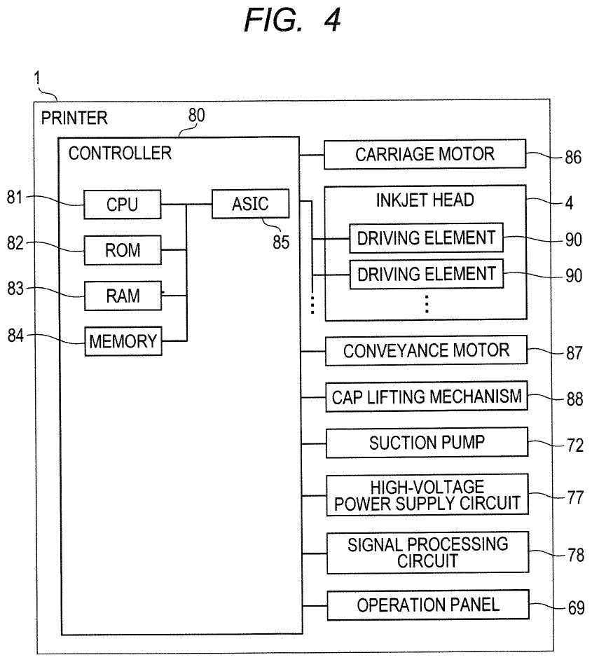

The carriage 2 is supported by two guide rails 11 and 12 extending in a horizontal scanning direction. In the following description, a right side and a left side in the scanning direction are defined as shown in FIG. 1. The carriage 2 is connected to a carriage motor 86 shown in FIG. 4 via a belt and so on (not shown). When the carriage motor 86 is driven, the carriage 2 moves in the scanning direction along the guide rails 11 and 12.

The inkjet head 4 is mounted on the carriage 2. The inkjet head 4 includes a plurality of nozzles 10 and a plurality of driving elements 90 shown in FIG. 4. The plurality of nozzles 10 are formed in a nozzle surface 4a which is a lower surface of the inkjet head 4. The plurality of nozzles 10 are arranged in a conveyance direction to form nozzle arrays 9, and four nozzle arrays 9 are arranged in the scanning direction on the nozzle surface 4a. The plurality of driving elements 90 are individually provided for the plurality of nozzles 10, and apply ejection energy to the ink in the respective nozzles 10. The driving element 90 is, for example, a piezoelectric actuator that applies pressure to ink in a pressure chamber (not shown) communicating with the nozzle 10 to apply ejection energy to the ink in the nozzle 10.

In the inkjet head 4, by driving the driving elements 90, the ink is ejected from the corresponding nozzles 10. The plurality of nozzles 10 eject black, yellow, cyan, and magenta inks in order from the nozzle array 9 on the right side in the scanning direction. The inkjet head 4 is connected to four ink cartridges (not shown) via tubes (not shown), and ink of the four colors is supplied from the four ink cartridges.

The platen 5 is disposed below the inkjet head 4 and faces the plurality of nozzles 10. The platen 5 extends over the entire length of a recording sheet S in the scanning direction and supports the recording sheet S from below. The conveyance roller 6 is disposed upstream of the inkjet head 4 and the platen 5 in the conveyance direction. The conveyance roller 7 is disposed downstream of the inkjet head 4 and the platen 5 in the conveyance direction. The conveyance rollers 6 and 7 are connected to a conveyance motor 87 shown in FIG. 4 via gears and so on (not shown). When the conveyance motor 87 is driven, the conveyance rollers 6 and 7 rotate, and the recording sheet S is conveyed in the conveyance direction.

The maintenance unit 8 includes a cap 71, a suction pump 72, and a waste liquid tank 73. The cap 71 is disposed on the right side of the platen 5 in the scanning direction. When the carriage 2 is located at a maintenance position on the right side of the platen 5 in the scanning direction, the plurality of nozzles 10 face the cap 71.

The cap 71 is connected to a cap lifting mechanism (cap lifter) 88 shown in FIG. 4. When the cap lifting mechanism 88 is driven, the cap 71 is moved up and down. When the cap 71 is lifted by the cap lifting mechanism 88 in a state where the plurality of nozzles 10 and the cap 71 face each other by locating the carriage 2 at the maintenance position, an upper end portion of the cap 71 is brought into close contact with the nozzle surface 4a and the plurality of nozzles 10 are covered by the cap 71, which is a capped state. In a state where the cap 71 is lowered, the plurality of nozzles 10 are not covered by the cap 71. The cap 71 is not limited to the one that covers the plurality of nozzles 10 by being in close contact with the nozzle surface 4a. The cap 71 may cover the plurality of nozzles 10 by being in close contact with a frame and so on (not shown) arranged at the periphery of the nozzle surface 4a of the inkjet head 4, for example.

The suction pump 72 is a tube pump and so on, and is connected to the cap 71 and the waste liquid tank 73. In the maintenance unit 8, when the suction pump 72 is driven in the capped state, the ink in the inkjet head 4 is discharged from the plurality of nozzles 10, that is, so-called suction purge is performed. The ink discharged by the suction purge is stored in the waste liquid tank 73.

In the above description, for convenience, the cap 71 covers all the nozzles 10 collectively, and the ink in the inkjet head 4 is discharged from all the nozzles 10 in the suction purge. However, the present disclosure is not limited to this configuration. For example, the cap 71 may include a portion that covers the nozzles 10 forming the rightmost nozzle array 9 for discharging black ink and a portion that covers the nozzles 10 forming the three nozzle arrays 9 on the left for discharging color ink, and may be configured to selectively discharge either black ink or color ink in the inkjet head 4 in the suction purge. The color ink is yellow, cyan, or magenta ink. Alternatively, for example, the cap 71 may be provided individually for each nozzle array 9, and the ink may be discharged from the nozzles 10 individually for each nozzle array 9 in the suction purge.

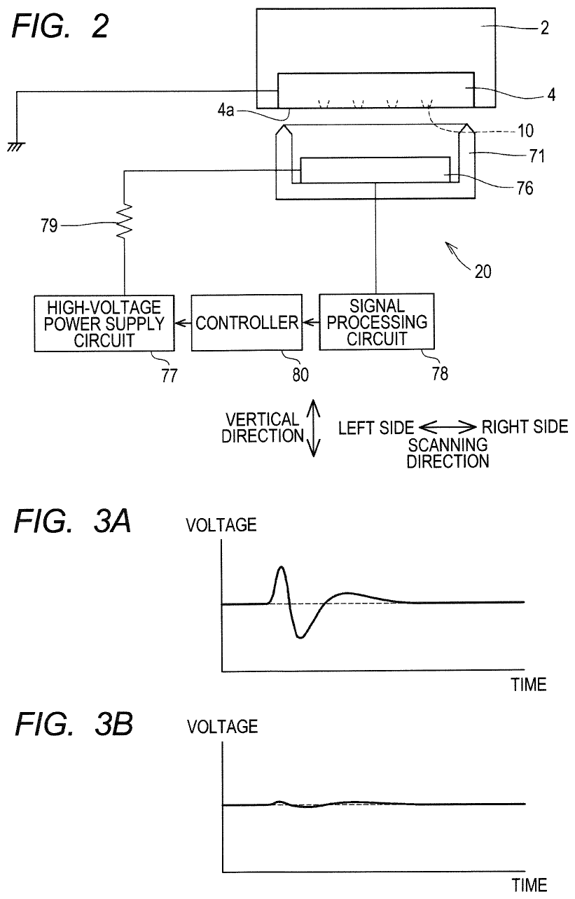

As shown in FIG. 2, the printer 1 includes an ejection inspection unit 20. The ejection inspection unit 20 includes an electrode 76, a high-voltage power supply circuit 77, a signal processing circuit 78, and a resistor 79.

The electrode 76 has a rectangular planar shape and is disposed in the cap 71. The electrode 76 is connected to the high-voltage power supply circuit 77 via the resistor 79. The high-voltage power supply circuit 77 applies a particular voltage, for example, approximately 600V, to the electrode 76. The inkjet head 4 is held at a ground potential. This causes a potential difference between the inkjet head 4 and the electrode 76. The signal processing circuit 78 is connected to the electrode 76. The signal processing circuit 78 includes a differential circuit and so on, and outputs an inspection signal which is a voltage signal corresponding to the voltage of the electrode 76. Alternatively, the inspection signal output from the signal processing circuit 78 may be a current signal.

In the first embodiment, in the capped state and in a state where a voltage is applied to the electrode 76 by the high-voltage power supply circuit 77, an inspection driving operation for ejecting ink from the nozzle 10 toward the electrode 76 by driving the corresponding driving element 90 is performed for each of the plurality of nozzles 10.

When ink is ejected from the nozzle 10 by the inspection driving operation, the ejected ink is charged due to the potential difference between the electrode 76 and the inkjet head 4. Thus, the potential of the electrode 76 changes until the charged ink approaches the electrode 76 and the ink lands on the electrode 76. Then, after the charged ink lands on the electrode 76, the potential of the electrode 76 returns to the potential before the ink is ejected while attenuating.

Accordingly, in a case where the ink is normally ejected from the nozzle 10 by the inspection driving operation, as shown in FIG. 3A, the voltage of the inspection signal output from the signal processing circuit 78 rises and then falls, and then repeats rising and falling while attenuating and returns to the voltage before the inspection driving operation.

In a case where the nozzle 10 is abnormal and the amount of ink ejected from the nozzle 10 by the inspection driving operation is smaller than that in the normal state, as shown in FIG. 3B, the voltage change in the inspection signal output from the signal processing circuit 78 is smaller than that in a case where ink is normally ejected from the nozzle 10. When it is said in this specification that the amount of ink ejected from the nozzle 10 is smaller than the amount of ink in a case where ink is normally ejected from the nozzle 10, that includes a case where ink is not ejected. In a case where ink is not ejected from the nozzle 10 by the inspection driving operation, the voltage of the inspection signal output from the signal processing circuit 78 does not change much (almost constant).

As described above, in the first embodiment, when the inspection driving operation is performed, the change in the voltage of the inspection signal output from the signal processing circuit 78 differs depending on whether ink is normally ejected from the nozzle 10. That is, the inspection signal output from the signal processing circuit 78 is a signal indicating whether the nozzle 10 is an abnormal nozzle having abnormality in the ejection of ink.

In the first embodiment, the particular voltage is applied to the electrode 76, the inkjet head 4 is held at the ground potential, and the signal processing circuit 78 outputs the signal corresponding to the voltage of the electrode 76. However, the present disclosure is not limited to this. The signal processing circuit 78 may be configured to be connected to the inkjet head 4 and output an inspection signal corresponding to the voltage of the inkjet head 4 by maintaining the electrode 76 at the ground potential and applying a particular voltage to the inkjet head 4 to generate a potential difference between the electrode 76 and the inkjet head 4.

Next, an electrical configuration of the printer 1 will be described. As shown in FIG. 4, the printer 1 includes a controller 80. The controller 80 includes a CPU 81, a ROM 82, a RAM 83, a memory 84, an ASIC 85, and so on. The controller 80 controls the carriage motor 86, the plurality of driving elements 90 of the inkjet head 4, the conveyance motor 87, the cap lifting mechanism 88, the suction pump 72, the high-voltage power supply circuit 77, the signal processing circuit 78, and so on.

In addition to the above-described configuration, the printer 1 includes an operation panel 69. The operation panel 69 is, for example, a touch panel provided on a housing of the printer 1. Operation screens, messages, and so on are displayed on the operation panel 69 by the control of the controller 80. When the user operates the operation panel 69 based on the operation screen and so on, a signal corresponding to the user's operation is transmitted to the controller 80. Instead of the operation panel 69, a display for displaying messages and so on and an operation interface for allowing the user to perform operations may be provided separately.

The controller 80 may be configured such that the CPU 81 performs various processes, the ASIC 85 performs various processes, or the CPU 81 and the ASIC 85 perform various processes in cooperation with each other. The controller 80 may be configured such that one CPU 81 performs the processes independently or a plurality of CPUs 81 perform the processes in a shared manner. The controller 80 may be configured such that one ASIC 85 performs the processes independently or a plurality of ASICs 85 perform the processes in a shared manner.

In the printer 1, the controller 80 controls the carriage motor 86 to move the carriage 2 in the scanning direction, and controls the inkjet head 4 to repeatedly perform a recording pass for ejecting ink from the nozzles 10 and a conveyance operation for controlling the conveyance motor 87 to convey the recording sheet S by the conveyance rollers 6 and 7, thereby performing recording on the recording sheet S.

Next, a process of the controller 80 when performing inspection of whether each of the plurality of nozzles 10 of the inkjet head 4 is an abnormal nozzle will be described.

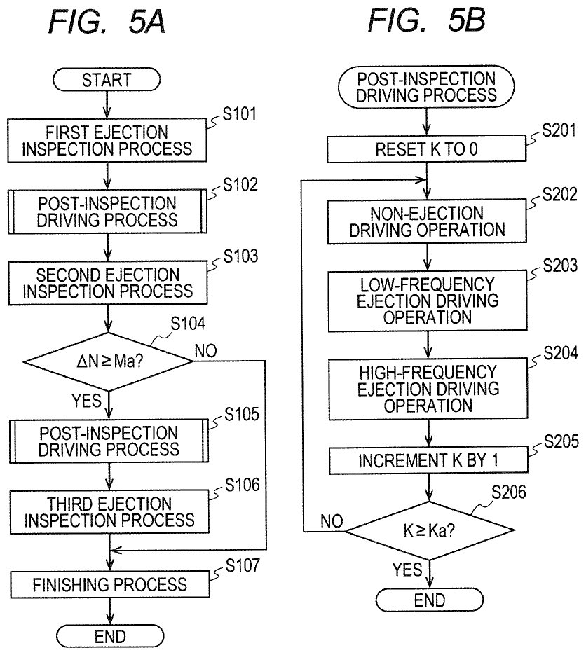

When performing the inspection, the controller 80 performs processing in accordance with the flowchart of FIG. 5A. For example, the flowchart of FIG. 5A is started when a particular time has come, when a recording instruction instructing the printer 1 to record an image on the recording sheet S has been received, when the user has instructed the inspection by operating the operation panel 69, and so on.

In the first embodiment, the description is given assuming that the processing is performed for all the nozzles 10 of the inkjet head 4 in accordance with the flowchart of FIG. 5A. However, the present disclosure is not limited to this. For example, the processing may be performed individually for each nozzle array 9 in accordance with the flowchart of FIG. 5A. The same applies to the following examples.

The flowchart of FIG. 5A will be described in detail. The controller 80 first performs a first ejection inspection process (S101). In the first ejection inspection process, the controller 80 controls the carriage motor 86, the cap lifting mechanism 88, and so on to set the capped state, and controls the high-voltage power supply circuit 77 to apply a particular voltage to the electrode 76, and then causes each of the plurality of nozzles 10 to perform the inspection driving operation. The controller 80 stores, in the memory 84, information indicating whether each of the plurality of nozzles of the inkjet head 4 is an abnormal nozzle, based on the inspection signal that is output from the signal processing circuit 78 when the inspection driving operation is performed for each nozzle 10. In the first embodiment, the operation for inspecting whether the nozzle is an abnormal nozzle, which is performed in the first ejection inspection process, is an example of “first ejection inspection” of the present disclosure.

Subsequently, the controller 80 performs a post-inspection driving process (S102). In the post-inspection driving process, the controller 80 performs the process in accordance with the flowchart of FIG. 5B. The flowchart of FIG. 5B will be described in detail. The controller 80 first resets a variable K to 0 (S201). The value of the variable K corresponds to the number of times of repetition of a non-ejection driving operation, a low-frequency ejection driving operation, and a high-frequency ejection driving operation described below.

Subsequently, the controller 80 causes the driving element 90 corresponding to the nozzle 10 for which the result of the first ejection inspection process indicates that the nozzle 10 is an abnormal nozzle to perform the non-ejection driving operation (S202). The non-ejection driving operation is an operation of driving the driving element 90 such that ejection energy smaller than ejection energy necessary for ejecting ink from the nozzle 10 is applied to the ink in the nozzle 10. When the non-ejection driving operation is performed, the ink in the individual ink channel of the abnormal nozzle and the nozzle 10 connected to the abnormal nozzle is stirred, and the viscosity increase (thickening) of the ink is reduced. In the first embodiment, the non-ejection driving operation is an example of “first driving operation” of the present disclosure.

Subsequently, the controller 80 causes the driving element 90 corresponding to the nozzle 10 for which the result of the first ejection inspection process indicates that the nozzle 10 is an abnormal nozzle to perform the low-frequency ejection driving operation (S203). The low-frequency ejection driving operation is an operation of driving the driving element 90 at a driving frequency lower than that of the high-frequency ejection driving operation described below to discharge the ink in the nozzle 10. When the low-frequency ejection driving operation is performed, the ink in the individual ink channel of the abnormal nozzle and the nozzle 10 connected to the abnormal nozzle is discharged, and ink having low viscosity is supplied to the ink channel from the ink cartridge side, and the viscosity increase of the ink is reduced. In the first embodiment, the low-frequency ejection driving operation is an example of “second driving operation” of the present disclosure.

Subsequently, the controller 80 causes the driving element 90 corresponding to the nozzle 10 for which the result of the first ejection inspection process indicates that the nozzle 10 is an abnormal nozzle to perform the high-frequency ejection driving operation (S204). The high-frequency ejection driving operation is an operation of driving the driving element 90 at a driving frequency higher than that of the low-frequency ejection driving operation of S203 to discharge the ink in the nozzle 10. When the high-frequency ejection driving operation is performed, the ink in the individual ink channel of the abnormal nozzle and the nozzle 10 connected to the abnormal nozzle is discharged, and ink having low viscosity is supplied to the ink channel from the ink cartridge side, and thus the viscosity increase of the ink is reduced. In the first embodiment, the high-frequency ejection driving operation is an example of “third driving operation” of the present disclosure.

Subsequently, the controller 80 increments the value of the variable K by 1 (S205), and determines whether the value of the variable K after the increment is greater than or equal to a particular value Ka (S206). In a case where the value of the variable K is less than the particular value Ka (S206: NO), the processing returns to S202, and in a case where the value of the variable K is greater than or equal to the particular value Ka (S206: YES), the processing returns to the flowchart of FIG. 5A. Thus, in the first embodiment, the non-ejection driving operation, the low-frequency ejection driving operation, and the high-frequency ejection driving operation are repeatedly performed Ka times in the post-inspection driving process. In the first embodiment, a combination of the non-ejection driving operation, the low-frequency ejection driving operation, and the high-frequency ejection driving operation, which are repeatedly performed Ka times, is an example of “post-inspection driving operation” of the present disclosure.

Returning to FIG. 5A, the controller 80 performs a second ejection inspection process (S103) following the post-inspection driving process of S102. In the second ejection inspection process, the controller 80 inspects whether each of the nozzles 10, which are indicated as abnormal nozzles by the result of the first ejection inspection process, is an abnormal nozzle, and stores the result in the memory 84. The procedure for inspecting whether each nozzle 10 is an abnormal nozzle is the same as that of the first ejection inspection process. In the first embodiment, the operation for inspecting whether a nozzle is an abnormal nozzle, which is performed in the second ejection inspection process of S103, is an example of “second ejection inspection” of the present disclosure.

Subsequently, the controller 80 determines whether a decrease number ΔN which is a difference between a number of abnormal nozzles N1 which is the number of nozzles 10 for which the result of the first ejection inspection process indicates that the nozzle is the abnormal nozzle and a number of abnormal nozzles N2 which is the number of nozzles 10 for which the result of the second ejection inspection process indicates that the nozzle is the abnormal nozzle, that is, [N1−N2] is greater than or equal to a first number Ma (S104). In the first embodiment, the condition that the decrease number ΔN is greater than or equal to the first number Ma is an example of “first condition” of the present disclosure.

In a case where the decrease number ΔN is less than the first number Ma (S104: NO), the controller 80 performs a finishing process (S107), and the processing ends. In the finishing process, the controller 80 performs, for example, various operations for returning to a standby state. In the first embodiment, the operations performed in the finishing process of S107 in a case where the decrease number ΔN is less than the first number Ma are an example of “second operation” of the present disclosure.

In a case where the decrease number ΔN is greater than or equal to the first number Ma (S104: YES), the controller 80 performs the post-inspection driving process (S105). Subsequently, the controller 80 performs a third ejection inspection process (S106).

In the third ejection inspection process, the controller 80 inspects whether each of the nozzles 10, for which the result of the second ejection inspection process indicates that the nozzles are abnormal nozzles, is an abnormal nozzle, and stores the result in the memory 84. The procedure for inspecting whether each nozzle 10 is an abnormal nozzle is the same as that of the first ejection inspection process.

Then, after the third ejection inspection process is completed, the controller 80 performs the finishing process (S107), and the processing ends. In the first embodiment, a combination of the operations performed in the post-inspection driving process of S105, the third ejection inspection process of S106, and the finishing process of S107 in a case where the decrease number ΔN is greater than or equal to the first number Ma is an example of “first operation” of the present disclosure.

In a case where the decrease number ΔN is large, the viscosity increase reduction effect by the post-inspection driving operation after the first ejection inspection is high. In a case where the decrease number ΔN is small, the viscosity increase reduction effect by the post-inspection driving operation after the first ejection inspection is low. Thus, in the first embodiment, in a case where the first condition that the decrease number ΔN is greater than or equal to the first number Ma is satisfied, the first operation including the post-inspection driving operation is performed after the second ejection inspection. In a case where the first condition is not satisfied, the second operation which is different from the first operation and does not include the post-inspection driving operation is performed after the second ejection inspection.

Accordingly, the viscosity increase of the ink in the nozzles 10 is efficiently suppressed in accordance with the results of the first and second ejection inspections. Specifically, in a case where the viscosity increase reduction effect of the post-inspection driving operation after the first ejection inspection is high, the post-inspection driving operation is performed after the second ejection inspection, and thus viscosity increase is further suppressed. In a case where the viscosity increase reduction effect of the post-inspection driving operation after the first ejection inspection is low, the post-inspection driving operation is not performed after the second ejection inspection, and thus the post-inspection driving operation having a low viscosity increase reduction effect is not repeated, which suppresses wasteful ink consumption and shortens the time required for the process.

In the first embodiment, the post-inspection driving operation and the second ejection inspection after the first ejection inspection are performed only for the nozzle 10 for which the result of the first ejection inspection process indicates an abnormal nozzle, and are not performed for the nozzle 10 for which the result of the first ejection inspection process does not indicate an abnormal nozzle. This reduces the time and the amount of ink required for the post-inspection driving operation and the second ejection inspection after the first ejection inspection. In the first embodiment, the post-inspection driving operation after the second ejection inspection is performed only for the nozzles 10 for which the result of the second ejection inspection process indicates an abnormal nozzle, and is not performed for the nozzle 10 for which the result of the second ejection inspection process does not indicate an abnormal nozzle. This reduces the time and the amount of ink required for the post-inspection driving operation after the second ejection inspection.

In the first embodiment, the post-inspection driving operation includes three types of driving operations, namely, the non-ejection driving operation of applying ejection energy smaller than the ejection energy required for ejecting ink from the nozzle 10 to the ink in the nozzle 10, and the low-frequency ejection driving operation and the high-frequency ejection driving operation of applying ejection energy required for ejecting ink from the nozzle 10. This has a higher effect of suppressing viscosity increase than a case where two or more kinds of driving operations are performed by applying ejection energy smaller than the ejection energy required for ejecting the ink from the nozzle 10. Further, the amount of ink consumption is suppressed compared with a case where all of the three types of driving operations are performed by applying the ejection energy required for ejecting the ink from the nozzle 10.

Further, viscosity increase of the ink in the nozzles 10 is efficiently suppressed compared with a case where the post-inspection driving operation includes two types of driving operations. Specifically, for example, ink is ejected from the nozzle 10 in both of the low-frequency ejection driving operation and the high-frequency ejection driving operation, but the driving frequency of the driving element 90 is different between the low-frequency ejection driving operation and the high-frequency ejection driving operation. Thus, the flow of ink in the ink channel differs between the low-frequency ejection driving operation and the high-frequency ejection driving operation, and the effect of suppressing viscosity increase due to the flow of ink also differs. Thus, as in the first embodiment, in a case where the post-inspection driving operation includes three types of driving operations, namely the non-ejection driving operation, the low-frequency ejection driving operation, and the high-frequency ejection driving operation, the viscosity increase of the ink in the nozzles 10 is efficiently suppressed compared with a case where the post-inspection driving operation includes two types of driving operations, namely the non-ejection driving operation and one of the low-frequency ejection driving operation and the high-frequency ejection driving operation.

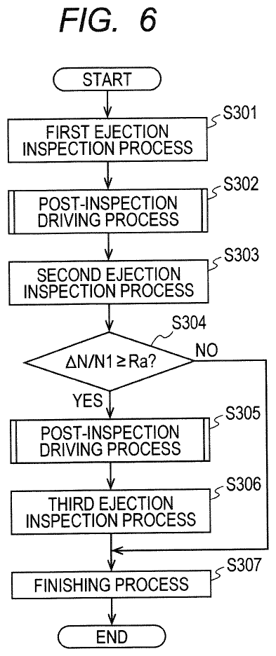

Next, a second embodiment of the present disclosure will be described. The second embodiment is also related to the printer 1 similar to the first embodiment. However, in the second embodiment, when performing inspection of whether each of the plurality of nozzles 10 of the inkjet head 4 is an abnormal nozzle, the controller 80 performs the processing in accordance with the flowchart of FIG. 6.

The flowchart of FIG. 6 will be described in detail. The controller 80 performs the processes of S301 to S303 similar to S101 to S103 in the first embodiment. Subsequently, the controller 80 determines whether a ratio [ΔN/N1] of the decrease number ΔN to the number of abnormal nozzles N1 is greater than or equal to a first value Ra (S304). In the second embodiment, the condition that the ratio [ΔN/N1] is greater than or equal to the first value Ra is an example of “first condition” of the present disclosure.

In a case where the ratio [ΔN/N1] is greater than or equal to the first value Ra (S304: YES), the controller 80 performs the post-inspection driving process (S305), then performs the third ejection inspection process (S306), then performs the finishing process (S307), and the processing ends. In a case where the ratio [ΔN/N1] is less than the first value Ra (S304: NO), the controller 80 performs the finishing process (S307), and the processing ends.

In a case where the ratio [ΔN/N1] is large, the viscosity increase reduction effect by the post-inspection driving operation after the first ejection inspection is high. In a case where the ratio [ΔN/N1] is small, the viscosity increase reduction effect by the post-inspection driving operation after the first ejection inspection is low. Thus, in the second embodiment, in a case where the first condition that the ratio [ΔN/N1] is greater than or equal to the first value Ra is satisfied, the first operation including the post-inspection driving operation is performed after the second ejection inspection. In a case where the first condition is not satisfied, the second operation which is different from the first operation and does not include the post-inspection driving operation is performed after the second ejection inspection. Accordingly, as described in the first embodiment, the viscosity increase of the ink in the nozzles 10 is efficiently suppressed in accordance with the results of the first and second ejection inspections.

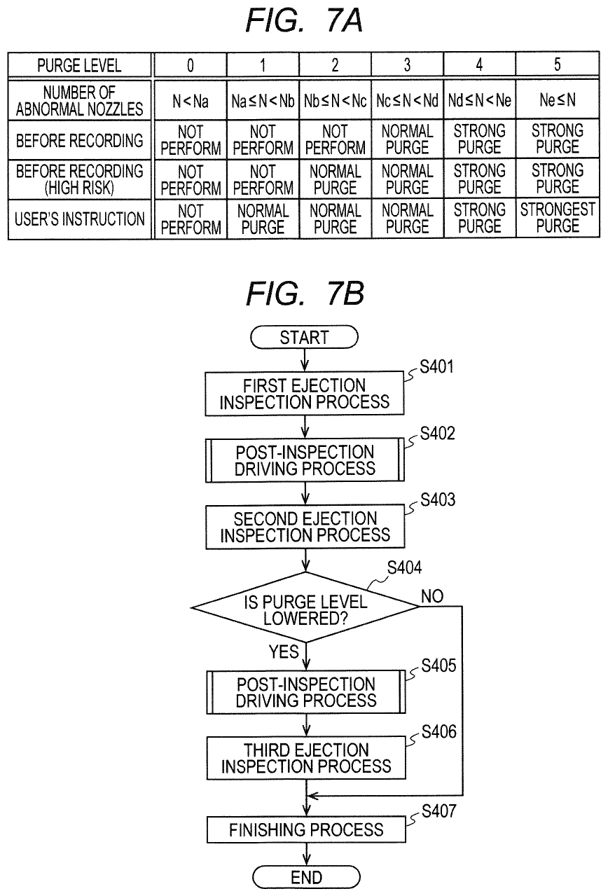

Next, a third embodiment of the present disclosure will be described. The third embodiment is also related to the printer 1 similar to the first embodiment. However, in the third embodiment, as shown in FIG. 7A, six purge levels of “0” to “5” are set depending on the range of the number of nozzles 10 for which the result of the ejection inspection process performed last time indicates an abnormal nozzle. Here, Na to Ne in FIG. 7A have a magnitude relationship of 0<=Na<Nb<Nc<Nd<Ne<Nt where the number of nozzles 10 of the inkjet head 4 is Nt.

As shown in FIG. 7A, in the third embodiment, whether to perform purge and the type of purge to be performed are set for each purge level and stored in the memory 84. In FIG. 7A, “not perform” indicates that the purge is not performed, and “normal purge”, “strong purge”, and “strongest purge” indicate the types of purge to be performed. The strong purge is a purge in which the discharge amount of ink is greater than that in the normal purge. The strongest purge is a purge in which the discharge amount of ink is greater than that in the strong purge.

As shown in FIG. 7A, in the third embodiment, whether to perform purge and the type of purge to be performed are set for three cases (situations) of “before recording”, “before recording (high risk)”, and “user's instruction”. The “before recording” in FIG. 7A is before recording on the recording sheet S other than the case of “before recording (high risk)”. The “before recording (high risk)” in FIG. 7A is before recording on a specific recording sheet S such as glossy paper. The “user's instruction” in FIG. 7A is a case when the user operates the operation panel 69 to instruct purge. In the third embodiment, whether to perform purge and the type of purge to be performed may be set in one or two of the three cases described above. Alternatively, whether to perform purge and the type of purge to be performed may be set for cases other than the three cases described above.

In the third embodiment, when performing inspection of whether each of the plurality of nozzles 10 of the inkjet head 4 is an abnormal nozzle, the controller 80 performs the processing in accordance with the flowchart of FIG. 7B.

The flowchart of FIG. 7B will be described in detail. The controller 80 performs processes S401 to S403 similar to S101 to S103 in the first embodiment. Subsequently, the controller 80 determines whether the purge level is lowered (S404). Here, that the purge level is lowered means that the purge level corresponding to the number of abnormal nozzles N2 is lower than the purge level corresponding to the number of abnormal nozzles N1.

In the third embodiment, the condition that the purge level is lowered is an example of “first condition” of the present disclosure. That is, a condition that the number of abnormal nozzles N1 is a number within a first range corresponding to any purge level and the number of abnormal nozzles N2 is a number within a second range corresponding to a lower purge level (in which the number of abnormal nozzles N is smaller than that of the first range) is an example of “first condition” of the present disclosure.

In a case where the purge level is lowered (S404: YES), the controller 80 performs the post-inspection driving process (S405), then performs the third ejection inspection process (S406), then performs the finishing process (S407), and the processing ends. In a case where the purge level is not lowered (S404: NO), the controller 80 performs the finishing process (S407), and the processing ends.

In a case where the purge level is lowered by the post-inspection driving operation after the first ejection inspection, the viscosity increase reduction effect by the post-inspection driving operation is high. In a case where the purge level is maintained before and after the post-inspection driving operation after the first ejection inspection, the viscosity increase reduction effect by the post-inspection driving operation is low. In the third embodiment, in a case where the first condition that the purge level is lowered is satisfied, the first operation including the post-inspection driving operation is performed after the second ejection inspection. In a case where the first condition is not satisfied, the second operation which is different from the first operation and does not include the post-inspection driving operation is performed after the second ejection inspection. Accordingly, as described in the first embodiment, the viscosity increase of the ink in the nozzles 10 is efficiently suppressed in accordance with the results of the first and second ejection inspections.

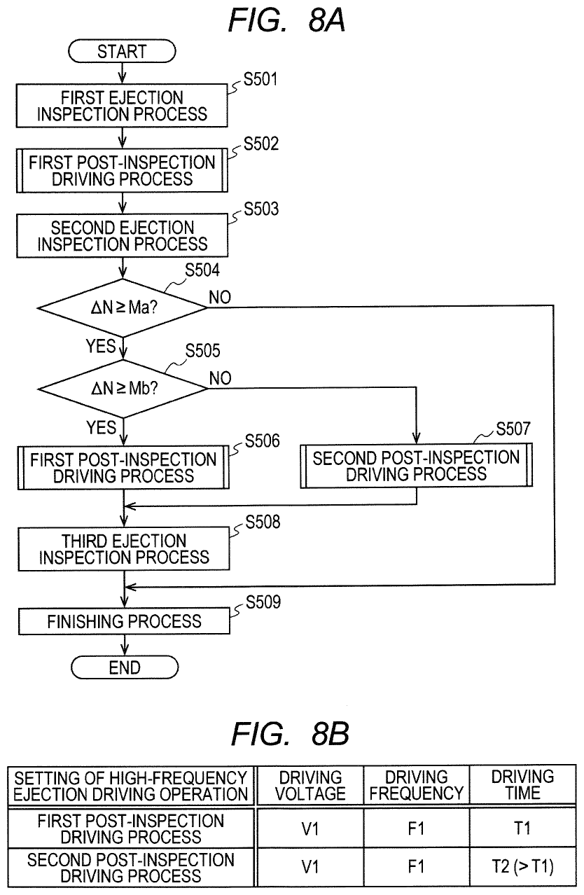

Next, a fourth embodiment of the present disclosure will be described. The fourth embodiment is also related to the printer 1 similar to the first embodiment. However, in the fourth embodiment, when performing inspection of whether each of the plurality of nozzles 10 of the inkjet head 4 is an abnormal nozzle, the controller 80 performs the processing in accordance with the flowchart of FIG. 8A.

The flowchart of FIG. 8A will be described in detail. The controller 80 performs the processes S501 to S504 similar to S101 to S104 in the first embodiment. However, in the fourth embodiment, the controller 80 performs a first post-inspection driving process in S502. The first post-inspection driving process and a second post-inspection driving process described later will be described in detail later. In a case where the decrease number ΔN is less than the first number Ma (S504: NO), the controller 80 performs the finishing process (S509), and the processing ends.

In a case where the decrease number ΔN is greater than or equal to the first number Ma (S504: YES), the controller 80 determines whether the decrease number ΔN is greater than or equal to a second number Mb greater than the first number Ma (S505). In a case where the decrease number ΔN is greater than or equal to the second number Mb (S505: YES), the controller 80 performs the first post-inspection driving process (S506). In a case where the decrease number ΔN is less than the second number Mb (S506: NO), the controller 80 performs the second post-inspection driving process (S507). After the first post-inspection driving process of S506 or the second post-inspection driving process of S507, the controller 80 subsequently performs the third ejection inspection process (S508), and subsequently performs the finishing process (S509), and the processing ends.

In the fourth embodiment, the condition that the decrease number ΔN is greater than or equal to the first number Ma is an example of “first condition” of the present disclosure. In the fourth embodiment, the condition that the decrease number ΔN is greater than or equal to the second number Mb is an example of “second condition” of the present disclosure.

Here, the first post-inspection driving process of S502 and S506 and the second post-inspection driving process of S507 will be described. In both the first post-inspection driving process and the second post-inspection driving process, the controller 80 performs the processing in accordance with the flowchart of FIG. 5B, similarly to the post-inspection driving process of the first embodiment. In the fourth embodiment, a combination of the non-ejection driving operation, the low-frequency ejection driving operation, and the high-frequency ejection driving operation repeated Ka times in the first post-inspection driving process is an example of “first post-inspection driving operation” of the present disclosure, and a combination of the non-ejection driving operation, the low-frequency ejection driving operation, and the high-frequency ejection driving operation repeated Ka times in the second post-inspection driving process is an example of “second post-inspection driving operation” of the present disclosure. In the fourth embodiment, a combination of the first post-inspection driving operation and the operations performed in the third ejection inspection process and the finishing process is an example of “first operation” of the present disclosure. In the fourth embodiment, a combination of the second post-inspection driving operation and the operations performed in the third ejection inspection process and the finishing process is an example of “second operation” of the present disclosure.

However, the driving condition of the driving element 90 in the high-frequency ejection driving operation is different between the first post-inspection driving process and the second post-inspection driving process. More specifically, as shown in FIG. 8B, in the first post-inspection driving process, in the high-frequency ejection driving operation, the driving element 90 is driven at a driving frequency F1 for a driving time T1 by applying a driving voltage V1 to the driving element 90. In the second post-inspection driving process, in the high-frequency ejection driving operation, the driving element 90 is driven at the driving frequency F1 for a driving time T2 longer than the driving time T1 by applying the driving voltage V1 to the driving element 90. Thus, the ejection energy applied to the ink in the nozzle 10 by the second post-inspection driving operation is greater than the ejection energy applied to the ink in the nozzle 10 by the first post-inspection driving operation.

In the fourth embodiment, in a case where the first condition that the decrease number ΔN is greater than or equal to the first number Ma is not satisfied, the post-inspection driving operation is not performed after the second ejection inspection. In a case where the first condition is satisfied and the second condition that the decrease number ΔN is greater than or equal to the second number Mb greater than the first number Ma is satisfied, the first post-inspection driving operation is performed after the second ejection inspection. In a case where the first condition is satisfied and the second condition is not satisfied after the second ejection inspection, the second post-inspection driving operation is performed in which the ejection energy applied to the ink in the nozzle 10 is greater than that in the first post-inspection driving operation.

Accordingly, the post-inspection driving operation is performed after the second ejection inspection in a case where the decrease number ΔN is large to some extent, and the post-inspection driving operation is not performed after the second ejection inspection in a case where the decrease number ΔN is small. Further, in a case where the decrease number ΔN is sufficiently large, that is, in a case where the viscosity increase reduction effect by the first post-inspection driving operation is sufficiently high, the first post-inspection driving operation is performed also after the second ejection inspection, and thus viscosity increase is further suppressed. In a case where the decrease number ΔN is not sufficiently large, that is, in a case where the viscosity increase reduction effect by the first post-inspection driving operation is not sufficiently high, the second post-inspection driving operation is performed after the second ejection inspection, and thus viscosity increase is further suppressed.

In the fourth embodiment, in the second post-inspection driving operation, the driving time of the driving element 90 in the high-frequency ejection driving operation is made longer than that in the first post-inspection driving operation, whereby the ejection energy applied to the ink in the nozzle 10 is increased.

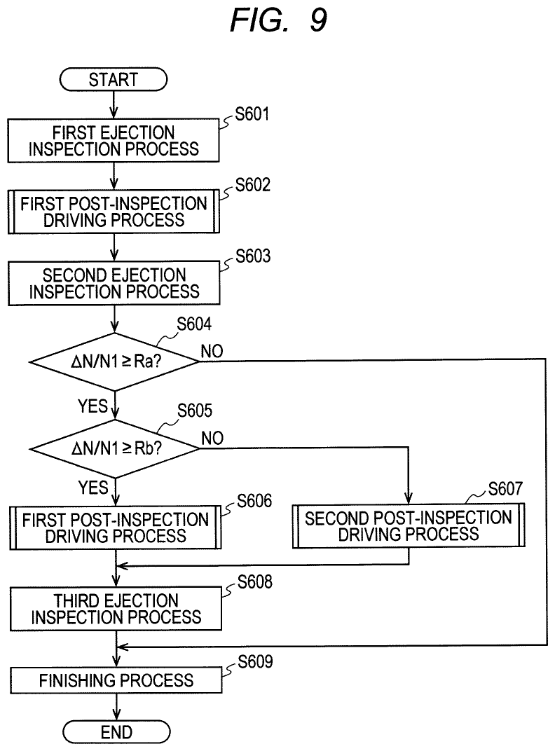

Next, a fifth embodiment of the present disclosure will be described. The fifth embodiment is also related to the printer 1 similar to the first embodiment. However, in the fifth embodiment, when performing inspection of whether each of the plurality of nozzles 10 of the inkjet head 4 is an abnormal nozzle, the controller 80 performs the processing in accordance with the flowchart of FIG. 9.

The flowchart of FIG. 9 will be described in detail. The controller 80 performs the processes S601 to S604 similar to S301 to S304 in the second embodiment. However, in the fifth embodiment, the controller 80 performs the first post-inspection driving process in S602. In a case where a ratio [ΔN/N1] is less than the first value Ra (S604: NO), the controller 80 performs the finishing process (S609), and the processing ends.

In a case where the ratio [ΔN/N1] is greater than or equal to the first value Ra (S604: YES), the controller 80 determines whether the ratio [ΔN/N1] is greater than or equal to a second value Rb that is greater than the first value Ra (S605). In a case where the ratio [ΔN/N1] is greater than or equal to the second value Rb (S605: YES), the controller 80 performs the first post-inspection driving process (S606). In a case where the ratio [ΔN/N1] is less than the second value Rb (S605: NO), the controller 80 performs the second post-inspection driving process (S607). After the first post-inspection driving process of S606 or the second post-inspection driving process of S607, the controller 80 subsequently performs the third ejection inspection process (S608), and subsequently performs the finishing process (S609), and the processing ends.

In the fifth embodiment, the condition that the ratio [ΔN/N1] is greater than or equal to the first value Ra is an example of “first condition” of the present disclosure. In the fifth embodiment, the condition that the ratio [ΔN/N1] is greater than or equal to the second value Rb is an example of “second condition” of the present disclosure.

In the fifth embodiment, in a case where the first condition that the ratio [ΔN/N1] is greater than or equal to the first value Ra is not satisfied, the post-inspection driving operation is not performed after the second ejection inspection. In a case where the first condition is satisfied and the second condition that the ratio [ΔN/N1] is greater than or equal to the second value Rb greater than the first value Ra is satisfied, the first post-inspection driving operation is performed after the second ejection inspection. In a case where the first condition is satisfied and the second condition is not satisfied after the second ejection inspection, the second post-inspection driving operation is performed in which the ejection energy applied to the ink in the nozzle 10 is greater than that in the first post-inspection driving operation.

Accordingly, the post-inspection driving operation is performed after the second ejection inspection in a case where the ratio [ΔN/N1] is large to some extent, and the post-inspection driving operation is not performed after the second ejection inspection in a case where the ratio [ΔN/N1] is small. Further, in a case where the ratio [ΔN/N1] is sufficiently large, that is, in a case where the viscosity increase reduction effect by the first post-inspection driving operation is sufficiently high, the first post-inspection driving operation is performed also after the second ejection inspection, and thus viscosity increase is further suppressed. In a case where the ratio [ΔN/N1] is not sufficiently large, that is, in a case where the viscosity increase reduction effect by the first post-inspection driving operation is not sufficiently high, the second post-inspection driving operation is performed after the second ejection inspection, and thus the viscosity increase reduction effect is improved.

Next, a sixth embodiment of the present disclosure will be described. The third embodiment is also related to the printer 1 similar to the first embodiment. In the sixth embodiment, as in the third embodiment, six purge levels “0” to “5” are set as shown in FIG. 7A.

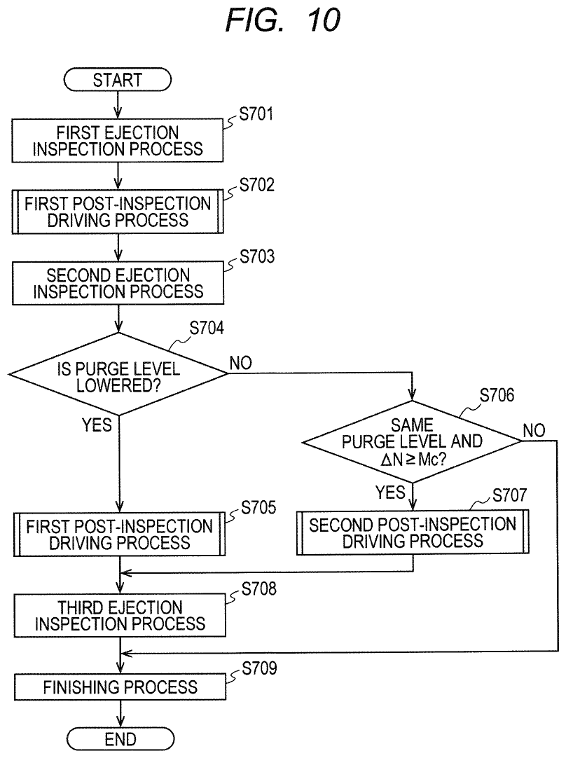

In the sixth embodiment, when performing inspection of whether each of the plurality of nozzles 10 of the inkjet head 4 is an abnormal nozzle, the controller 80 performs the processing in accordance with the flowchart of FIG. 10.

The flowchart of FIG. 10 will be described in detail. The controller 80 performs the processes S701 to S704 similar to S401 to S404 in the third embodiment. However, in the sixth embodiment, the controller 80 performs the first post-inspection driving process in S702. In a case where the purge level is lowered (S704: YES), the controller 80 performs the first post-inspection driving process (S705), then performs the third ejection inspection process (S708), then performs the finishing process (S709), and the processing ends.

In a case where the purge level is not lowered (S704: NO), the controller 80 determines whether the purge level corresponding to the number of abnormal nozzles N2 is the same as the purge level corresponding to the number of abnormal nozzles N1 and the decrease number ΔN is greater than or equal to a third number Mc (S706).

Here, the third number Mc is a number set in accordance with the range of the number of abnormal nozzles corresponding to the purge level corresponding to the number of abnormal nozzles N1. For example, the third number Mc may be a number obtained by dividing the range of the number of abnormal nozzles corresponding to the purge level corresponding to the number of abnormal nozzles N1 by a number A greater than 1. In this case, for example, in a case where the purge level corresponding to the number of abnormal nozzles N1 is “2”, the range of the number of abnormal nozzles is greater than or equal to Nb and less than Nc, and the third number Mc is a number calculated by [(Nc−Nb)/A].

In a case where the purge level corresponding to the number of abnormal nozzles N2 is the same as the purge level corresponding to the number of abnormal nozzles N1 and the decrease number ΔN is greater than or equal to the third number Mc (S706: YES), the controller 80 performs the second post-inspection driving process (S707), then performs the third ejection inspection process (S708), then performs the finishing process (S709), and the processing ends.

In a case where the purge level corresponding to the number of abnormal nozzles N2 is the same as the purge level corresponding to the number of abnormal nozzles N1 and the decrease number ΔN is less than the third number Mc (S706: NO), the controller 80 performs the finishing process (S709) and the processing ends.

In the sixth embodiment, a condition satisfying any one of the following conditions is an example of “first condition” of the present disclosure: (A) the purge level is lowered; and (B) the purge level corresponding to the number of abnormal nozzles N2 is the same as the purge level corresponding to the number of abnormal nozzles N1 and the decrease number ΔN is greater than or equal to the third number Mc. That is, a condition satisfying any one of the following conditions is an example of “first condition” of the present disclosure: (A) a condition that the number of abnormal nozzles N1 is a number within a first range corresponding to a certain purge level and the number of abnormal nozzles N2 is a number within a second range (in which the number of abnormal nozzles N is smaller than that in the first range) corresponding to a purge level lower than the certain purge level; and (B) a condition that both the number of abnormal nozzles N1 and the number of abnormal nozzles N2 are numbers within the first range corresponding to the same purge level and the decrease number ΔN is greater than or equal to the third number Mc determined based on the first range. In the sixth embodiment, the condition (A) is an example of “second condition” of the present disclosure.

In the sixth embodiment, the post-inspection driving operation is not performed after the second ejection inspection in a case where the first condition is not satisfied, the first condition being that any one of the following conditions is satisfied: (A) the purge level is lowered; and (B) the purge level corresponding to the number of abnormal nozzles N2 is the same as the purge level corresponding to the number of abnormal nozzles N1 and the decrease number ΔN is greater than or equal to the third number Mc. In a case where the first condition is satisfied and the second condition which is the condition (A) is satisfied, the first post-inspection driving operation is performed after the second ejection inspection. In a case where the first condition is satisfied and the second condition is not satisfied after the second ejection inspection, the second post-inspection driving operation is performed in which the ejection energy applied to the ink in the nozzle 10 is greater than that in the first post-inspection driving operation.

Accordingly, in a case where the number of abnormal nozzles reduced by the first post-inspection driving operation after the first ejection inspection is large to a certain extent, the post-inspection driving operation is performed after the second ejection inspection, and in a case where the number of abnormal nozzles reduced by the first post-inspection driving operation after the first ejection inspection is small, the post-inspection driving operation having a low viscosity increase reduction effect is not performed after the second ejection inspection. Further, in a case where the number of abnormal nozzles reduced by the first post-inspection driving operation after the first ejection inspection is large enough to lower the purge level, that is, in a case where the viscosity increase reduction effect by the first post-inspection driving operation is sufficiently high, the first post-inspection driving operation is performed after the second ejection inspection, and thus viscosity increase is further suppressed. In a case where the number of abnormal nozzles is reduced to some extent by the first post-inspection driving operation after the first ejection inspection, but the purge level is maintained before and after the first post-inspection driving operation, that is, in a case where the viscosity increase reduction effect by the first post-inspection driving operation is not sufficiently high, the second post-inspection driving operation is performed after the second ejection inspection, and thus the viscosity increase reduction effect is improved.

Next, seventh to twelfth embodiments of the present disclosure will be described. The seventh to twelfth embodiments are also related to the printer 1 similar to the first embodiment. In the seventh to twelfth embodiments, when performing inspection of whether each of the plurality of nozzles 10 of the inkjet head 4 is an abnormal nozzle, the controller 80 performs the processing in accordance with the flowchart of any one of FIGS. 8A, 9, and 10. When the controller 80 performs the processing in accordance with the flowchart of FIG. 10, six purge levels of “0” to “5” are set as shown in FIG. 7A, as in the third embodiment.

However, in the seventh to twelfth embodiments, the first post-inspection driving process and the second post-inspection driving process are different from those described in the fourth embodiment. Hereinafter, the first post-inspection driving process and the second post-inspection driving process in each embodiment will be described.

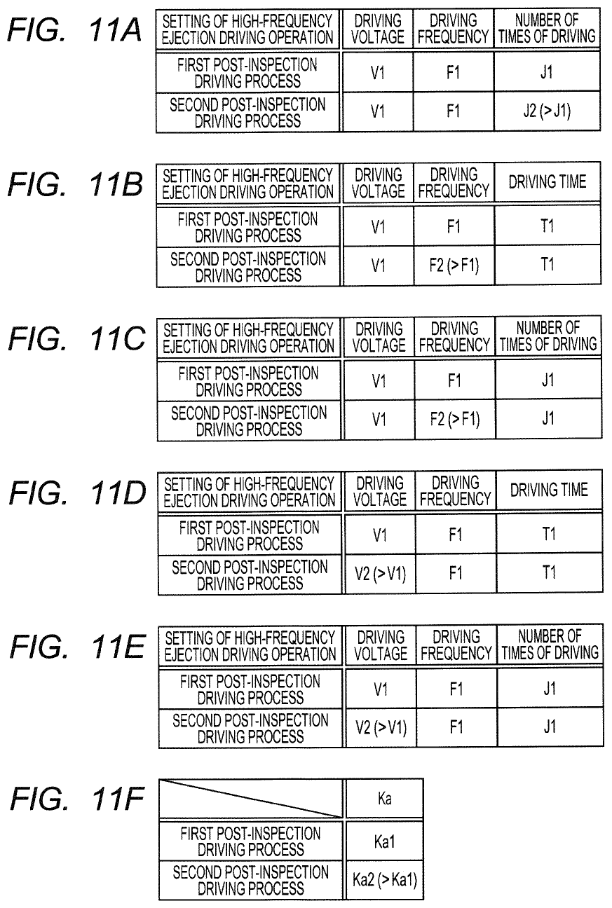

In the seventh embodiment, as shown in FIG. 11A, in the high-frequency ejection driving operation performed in the first post-inspection driving process, the driving element 90 is driven at the driving frequency F1 a number of times of driving J1 by applying the driving voltage V1 to the driving element 90. In the high-frequency ejection driving operation performed in the second post-inspection driving process, the driving element 90 is driven at the driving frequency F1 a number of times of driving J2 which is greater than the number of times of driving J1 by applying the driving voltage V1 to the driving element 90.

In the seventh embodiment, in the second post-inspection driving operation, the number of times of driving of the driving element 90 in the high-frequency ejection driving operation is set to be greater than that in the first post-inspection driving operation, thereby increasing the ejection energy applied to the ink in the nozzle 10.

In the eighth embodiment, as shown in FIG. 11B, in the high-frequency ejection driving operation performed in the first post-inspection driving process, the driving element 90 is driven for the driving time T1 at the driving frequency F1 by applying the driving voltage V1 to the driving element 90. In the high-frequency ejection driving operation performed in the second post-inspection driving process, the driving element 90 is driven for the driving time T1 at a driving frequency F2 higher than the driving frequency F1 by applying the driving voltage V1 to the driving element 90.

In the ninth embodiment, as shown in FIG. 11C, in the high-frequency ejection driving operation performed in the first post-inspection driving process, the driving element 90 is driven the number of times of driving J1 at the driving frequency F1 by applying the driving voltage V1 to the driving element 90. In the high-frequency ejection driving operation performed in the second post-inspection driving process, the driving element 90 is driven the number of times of driving J1 at the driving frequency F2 higher than the driving frequency F1 by applying the driving voltage V1 to the driving element 90.

In the eighth and ninth embodiments, in the second post-inspection driving operation, the driving frequency of the driving element 90 in the high-frequency ejection driving operation is made higher than that in the first post-inspection driving operation, thereby increasing the ejection energy applied to the ink in the nozzle 10.

In the tenth embodiment, as shown in FIG. 11D, in the high-frequency ejection driving operation performed in the first post-inspection driving process, the driving element 90 is driven at the driving frequency F1 for the driving time T1 by applying the driving voltage V1 to the driving element 90. In the high-frequency ejection driving operation performed in the second post-inspection driving process, the driving element 90 is driven at the driving frequency F1 for the driving time T1 by applying a driving voltage V2 higher than the driving voltage V1 to the driving element 90.

In the eleventh embodiment, as shown in FIG. 11E, in the high-frequency ejection driving operation performed in the first post-inspection driving process, the driving element 90 is driven the number of times of driving J1 at the driving frequency F1 by applying the driving voltage V1 to the driving element 90. In the high-frequency ejection driving operation performed in the second post-inspection driving process, the driving element 90 is driven the number of times of driving J1 at the driving frequency F1 by applying the driving voltage V2 higher than the driving voltage V1 to the driving element 90.

In the tenth and eleventh embodiments, in the second post-inspection driving operation, the driving voltage applied to the driving element 90 in the high-frequency ejection driving operation is made higher than that in the first post-inspection driving operation, thereby increasing the ejection energy applied to the ink in the nozzle 10.

In the twelfth embodiment, in both the first post-inspection driving process and the second post-inspection driving process, the same non-ejection driving operation, low-frequency ejection driving operation, and high-frequency ejection driving operation are performed when the processing is performed in accordance with the flowchart of FIG. 5B. However, in the twelfth embodiment, the particular value Ka used when the processing is performed in accordance with the flowchart of FIG. 5B is different between the first post-inspection driving process and the second post-inspection driving process. Specifically, as shown in FIG. 11F, when the first post-inspection driving process is performed, the particular value Ka is set to Ka1. When the second post-inspection driving process is performed, the particular value Ka is set to Ka2, which is greater than Ka1. That is, in the twelfth embodiment, the number of repetitions of the non-ejection driving operation, the low-frequency ejection driving operation, and the high-frequency ejection driving operation is larger in the second post-inspection driving process than in the first post-inspection driving process.

In the twelfth embodiment, in the second post-inspection driving operation, the number of repetitions of the non-ejection driving operation, the low-frequency ejection driving operation, and the high-frequency ejection driving operation is larger than in the first post-inspection driving operation, and thus the ejection energy applied to the ink in the nozzle 10 is increased.

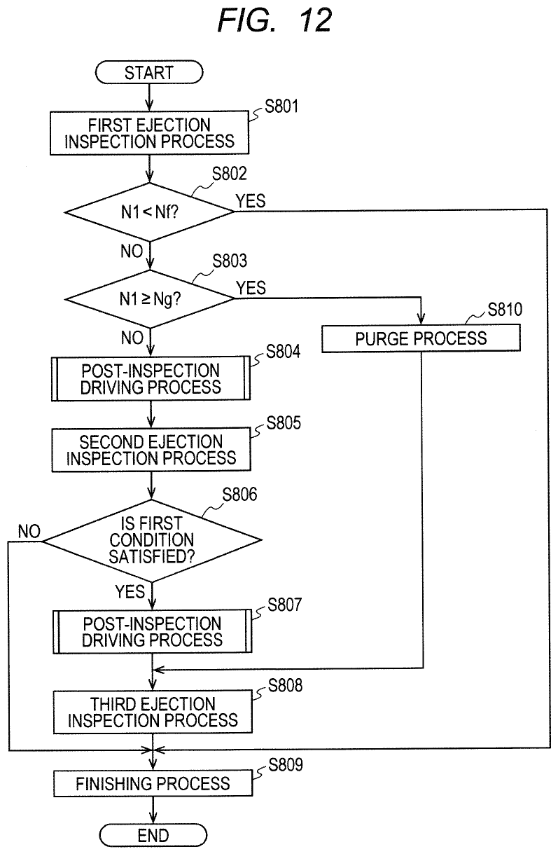

Next, a thirteenth embodiment of the present disclosure will be described. The thirteenth embodiment is also related to the printer 1 similar to the first embodiment. However, in the thirteenth embodiment, when performing inspection of whether each of the plurality of nozzles 10 of the inkjet head 4 is an abnormal nozzle, the controller 80 performs the processing in accordance with the flowchart of FIG. 12.

The flowchart of FIG. 12 will be described in detail. The controller 80 performs the first ejection inspection process (S801). Subsequently, the controller 80 determines whether the number of abnormal nozzles N1 is less than a fourth number Nf (first threshold) and whether the number of abnormal nozzles N1 is greater than or equal to a fifth number Ng (second threshold) (S802, S803). Here, the fourth number Nf and the fifth number Ng are numbers satisfying a magnitude relationship 0<Nf<Ng<Nt where the number of the nozzles 10 of the inkjet head 4 is Nt.

In a case where the number of abnormal nozzles N1 is not less than the fourth number Nf (S802: NO) and the number of abnormal nozzles N1 is not greater than or equal to the fifth number Ng (S803: NO), that is, in a case where the number of abnormal nozzles N1 is greater than or equal to the fourth number Nf and less than the fifth number Ng, the controller 80 performs the post-inspection driving process (S804) and then performs the second ejection inspection process (S805).

Subsequently, the controller 80 determines whether the first condition is satisfied (S806). The first condition in S806 is, for example, the same condition as the first condition in any of the first to third embodiments. In a case where the first condition is satisfied (S806: YES), the controller 80 performs the post-inspection driving process (S807), then performs the third ejection inspection process (S808), then performs the finishing process (S809), and the processing ends. In a case where the first condition is not satisfied (S806: NO), the controller 80 performs the finishing process (S809), and the processing ends.

In a case where the number of abnormal nozzles N1 is less than the fourth number Nf (S802: YES), the controller 80 performs the finishing process (S809), and the processing ends.

In a case where the number of abnormal nozzles N1 is greater than or equal to the fifth number Ng (S802: NO, S803: YES), the controller 80 performs a purge process (S810). In the purge process, the controller 80 controls the carriage motor 86, the cap lifting mechanism 88, the suction pump 72, and so on to perform a suction purge. Subsequently, the controller 80 performs the third ejection inspection process (S808), and then performs the finishing process (S809), and the processing ends.

In the thirteenth embodiment, in a case where the number of abnormal nozzles N1 is greater than or equal to the fourth number Nf, that is, the number of abnormal nozzles N1 is large to some extent, the post-inspection driving operation is performed after the first ejection inspection, and thus the viscosity increase is further suppressed. In a case where the number of abnormal nozzles N1 is less than the fourth number Nf, which is small, the necessity of suppressing the viscosity increase is low, and thus the post-inspection driving operation is not performed after the first ejection inspection, thereby preventing the post-inspection driving operation from being unnecessarily performed. In a case where the number of abnormal nozzles N1 is greater than or equal to the fifth number Ng, which is too large, the ink in the inkjet head 4 is highly thickened, and thus the viscosity increase is unlikely to be reduced even if the post-inspection driving operation is performed after the first ejection inspection. Thus, the post-inspection driving operation is not performed after the first ejection inspection, thereby preventing the post-inspection driving operation from being unnecessarily performed.

In the thirteenth embodiment, in a case where the number of abnormal nozzles N1 is greater than or equal to the fifth number Ng, which is too large, the suction purge is performed after the first ejection inspection, and thus the viscosity increase of the ink in the nozzles 10 is suppressed.

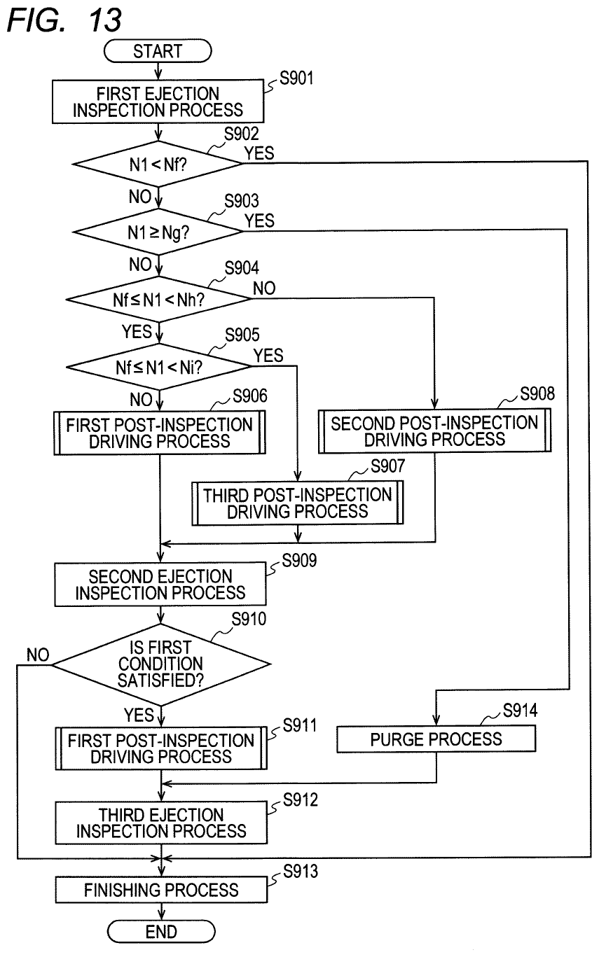

Next, a fourteenth embodiment of the present disclosure will be described. The fourteenth embodiment is also related to the printer 1 similar to the first embodiment. However, in the fourteenth embodiment, when performing inspection of whether each of the plurality of nozzles 10 of the inkjet head 4 is an abnormal nozzle, the controller 80 performs the processing in accordance with the flowchart of FIG. 13.

The flowchart of FIG. 13 will be described in detail. The controller 80 performs the first ejection inspection process similar to S101 of the first embodiment (S901). Subsequently, the controller 80 determines whether the number of abnormal nozzles N1 is less than the fourth number Nf and whether the number of abnormal nozzles N1 is greater than or equal to the fifth number Ng (S902, S903).

In a case where the number of abnormal nozzles N1 is not less than the fourth number Nf (S902: NO) and the number of abnormal nozzles N1 is not greater than or equal to the fifth number Ng (S903: NO), that is, in a case where the number of abnormal nozzles N1 is greater than or equal to the fourth number Nf and less than the fifth number Ng, the controller 80 determines whether the number of abnormal nozzles N1 is greater than or equal to the fourth number Nf and less than a sixth number Nh (third threshold) (S904). Here, the sixth number Nh is a number satisfying a magnitude relation of Nf<Nh<Ng. In a case where the number of abnormal nozzles N1 is greater than or equal to the fourth number Nf and less than the sixth number Nh (S904: YES), the controller 80 determines whether the number of abnormal nozzles N1 is greater than or equal to the fourth number Nf and less than a seventh number Ni (S905). Here, the seventh number Ni is a number satisfying the magnitude relation of Nf<Ni<Nh.

In a case where the number of abnormal nozzles N1 is greater than or equal to the seventh number Ni and less than the sixth number Nh (S905: NO), the controller 80 performs the first post-inspection driving process (S906). The first post-inspection driving process of the S906 is a process similar to the first post-inspection driving process of any one of the fourth to twelfth embodiments.

In a case where the number of abnormal nozzles N1 is greater than or equal to the fourth number Nf and less than the seventh number Ni (S905: YES), the controller 80 performs a third post-inspection driving process (S907). In the third post-inspection driving process, the controller 80 performs the non-ejection driving operation, the low-frequency ejection driving operation, and the high-frequency ejection driving operation, as in the first post-inspection driving process. In the third post-inspection driving process, the controller 80 performs the high-frequency ejection driving operation with drive conditions of the driving element 90 which are different from those in the first post-inspection driving process, thereby making the ejection energy applied to the ink in the nozzle 10 smaller than that in the first post-inspection ejection driving process.

For example, in the third post-inspection driving process, the driving time of the driving element 90 in the high-frequency ejection driving operation is set to be shorter than that in the first post-inspection driving process. Alternatively, for example, in the third post-inspection driving process, the driving frequency of the driving element 90 in the high-frequency ejection driving operation is set to be lower than that in the first post-inspection driving process. Alternatively, for example, in the third post-inspection driving process, the number of times of driving the driving element 90 in the high-frequency ejection driving operation is set to be smaller than that in the first post-inspection driving process. Alternatively, for example, in the third post-inspection driving process, the driving voltage of the driving element 90 in the high-frequency ejection driving operation is set to be lower than that in the first post-inspection driving process. Alternatively, in the third post-inspection driving process, the number of repetitions of the three types of driving operations in the high-frequency ejection driving operation is set to be smaller than that in the first post-inspection driving process. In the fourteenth embodiment, the non-ejection driving operation, the low-frequency ejection driving operation, and the high-frequency ejection driving operation performed in the first post-inspection driving process of S906 and the third post-inspection driving process of S907 are an example of “first post-inspection driving operation” of the present disclosure.

In a case where the number of abnormal nozzles N1 is greater than or equal to the sixth number Nh and less than the fifth number Ng (S904: NO), the controller 80 performs the second post-inspection driving process (S908). The second post-inspection driving process of the S908 is a process similar to the second post-inspection driving process of any one of the fourth to twelfth embodiments.

After performing one of the first post-inspection driving process of S906, the third post-inspection driving process of S907, and the second post-inspection driving process of S908, the controller 80 performs the second ejection inspection process (S909), and then determines whether the first condition is satisfied (S910). The first condition in the S910 is, for example, the same condition as the first condition in any of the first to third embodiments.

In a case where the first condition is satisfied (S910: YES), the controller 80 performs the first post-inspection driving process (S911), then performs the third ejection inspection process (S912), then performs the finishing process (S913), and the processing ends. In a case where the first condition is not satisfied (S910: NO), the controller 80 performs the finishing process (S913), and the processing ends.

In a case where the number of abnormal nozzles N1 is less than the fourth number Nf (S902: YES), the controller 80 performs the finishing process (S913), and the processing ends. In a case where the number of abnormal nozzles N1 is greater than or equal to the fifth number Ng (S902: NO, S903: YES), the controller 80 performs the purge process (S914), subsequently performs the third ejection inspection process (S912), subsequently performs the finishing process (S913), and the processing ends.

As the number of abnormal nozzles increases, a possibility that the ink is greatly thickened increases. In the fourteenth embodiment, in a case where the number of abnormal nozzles N1 is greater than or equal to the fourth number Nf and less than the seventh number Ni, the third post-inspection driving operation in which the ejection energy applied to the ink in the nozzle 10 is smaller than that in the first post-inspection driving operation is performed after the first ejection inspection. In a case where the number of abnormal nozzles N1 is greater than or equal to the seventh number Ni and less than the sixth number Nh, the first post-inspection driving operation is performed after the first ejection inspection. In a case where the number of abnormal nozzles N1 is greater than or equal to the sixth number Nh and less than the fifth number Ng, the second post-inspection driving operation in which the ejection energy applied to the ink in the nozzle 10 is greater than that in the first post-inspection driving operation is performed after the first ejection inspection. Thus, the post-inspection driving operation after the first ejection inspection is appropriate in accordance with the degree of viscosity increase (thickening) of the ink.

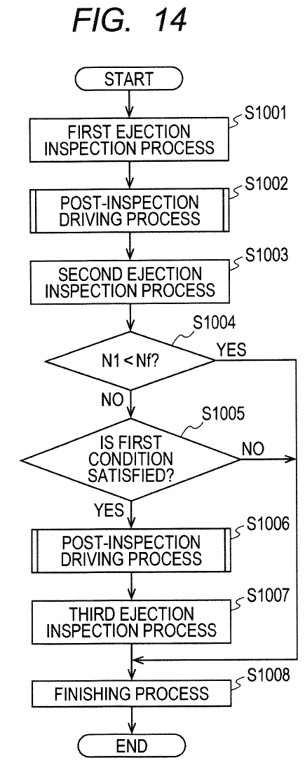

Next, a fifteenth embodiment of the present disclosure will be described. The fifteenth embodiment is also related to the printer 1 similar to the first embodiment. However, in the fifteenth embodiment, when performing inspection of whether each of the plurality of nozzles 10 of the inkjet head 4 is an abnormal nozzle, the controller 80 performs the processing in accordance with the flowchart of FIG. 14.

The flowchart of FIG. 14 will be described in detail. The controller 80 performs processes S1001 to S1003 similar to S101 to S103 of the first embodiment. Subsequently, the controller 80 determines whether the number of abnormal nozzles N1 is less than the fourth number Nf (S1004). In a case where the number of abnormal nozzles N1 is greater than or equal to the fourth number Nf (S1004: NO), the controller 80 performs processes S1005 to S1008 similar to S806 to S809 of the thirteenth embodiment, and the processing ends.

In a case where the number of abnormal nozzles N1 is less than the fourth number Nf (S1004: YES), the controller 80 performs the finishing process (S1008), and the processing ends. That is, in a case where the number of abnormal nozzles N1 is less than the fourth number Nf, the controller 80 does not perform the post-inspection driving process after the second ejection inspection.

In a case where the number of abnormal nozzles N1 is sufficiently small, the number of abnormal nozzles is sufficiently small after the post-inspection driving operation after the first ejection inspection. Thus, in the present embodiment, in such a case, the post-inspection driving operation is not performed after the second ejection inspection regardless of the result of the second ejection inspection. This prevents an unnecessary post-inspection driving operation from being performed.

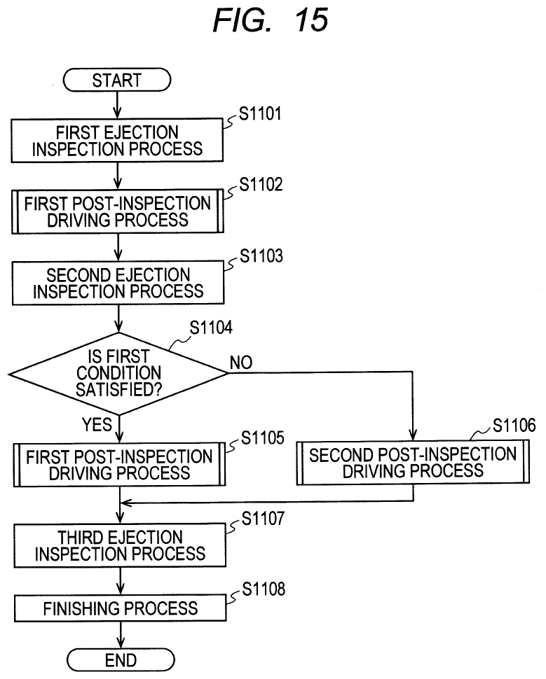

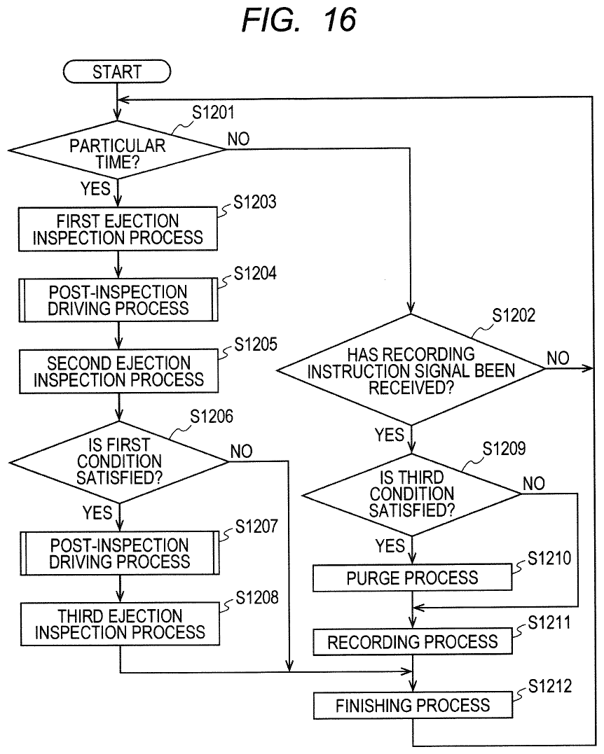

Next, a sixteenth embodiment of the present disclosure will be described. The sixteenth embodiment is also related to the printer 1 similar to the first embodiment. However, in the sixteenth embodiment, when performing inspection of whether each of the plurality of nozzles 10 of the inkjet head 4 is an abnormal nozzle, the controller 80 performs the processing in accordance with the flowchart of FIG. 15.

The flowchart of FIG. 15 will be described in detail. The controller 80 performs processes S1101 to S1103 similar to S501 to S503 of the fourth embodiment. Subsequently, the controller 80 determines whether the first condition is satisfied (S1104). Here, the first condition in S1104 is, for example, any of the first conditions described in the first to third embodiments.

In a case where the first condition is satisfied (S1104: YES), the controller 80 performs the first post-inspection driving process (S1105). In a case where the first condition is not satisfied (S1104: NO), the controller 80 performs the second post-inspection driving process (S1106). The first post-inspection driving process of S1102 and S1105 and the second post-inspection driving process of S1106 are the same as those described in any of the fourth to twelfth embodiments.

After performing either the first post-inspection driving process of S1105 or the second post-inspection driving process of S1106, the controller 80 performs the third ejection inspection process (S1107), and then performs the finishing process (S1108), and the processing ends.

In the sixteenth embodiment, the driving condition of the driving element 90 in at least one driving operation of the plurality of types of driving operations is different between the first post-inspection driving operation performed in the first operation and the second post-inspection driving operation performed in the second operation. Thus, the viscosity increase of ink is efficiently suppressed depending on the results of the first and second ejection inspections.

Next, a seventeenth embodiment of the present disclosure will be described. The seventeenth embodiment is also related to the printer 1 similar to the first embodiment. However, in the seventeenth embodiment, the controller 80 performs the processing in accordance with the flowchart of FIG. 16 while power is supplied to the printer 1.

The flowchart of FIG. 16 will be described in detail. The controller 80 waits when a particular time has not come (S1201: NO) and a recording instruction signal instructing recording on the recording sheet S has not been received (S1202: NO). In the seventeenth embodiment, the recording instruction signal is an example of “ejection instruction signal” of the present disclosure.

When the particular time has come (S1201: YES), the controller 80 performs processes S1203 to S1205 similar to $101 to S103 of the first embodiment, and subsequently performs processes S1206 to S1208, S1212 similar to S806 to S809 of the thirteenth embodiment, and the processing returns to S1201.

In response to receiving the recording instruction signal (S1202: YES), the controller 80 determines whether a third condition (purge condition) regarding the result of the second ejection inspection performed last is satisfied (S1209). Here, the third condition is a condition that is satisfied when the necessity of performing purge before recording on the recording sheet S is high, with respect to the result of the second ejection inspection. The third condition may be, for example, a condition that “the number of abnormal nozzles N2 is greater than or equal to a particular number”. Alternatively, the third condition may be, for example, a condition that “a ratio [N2/Nt] of the number of abnormal nozzles N2 to the number of nozzles 10 of the inkjet head 4 (=Nt) is greater than or equal to a particular value”.

In a case where the third condition is satisfied (S1209: YES), the controller 80 performs a purge process (S1210), and then performs a recording process (S1211). In a case where the third condition is not satisfied (S1209: NO), the controller 80 performs the recording process without performing the purge process (S1211). In the recording process of S1211, the controller 80 performs recording on the recording sheet S by repeatedly performing the recording pass and the conveyance operation as described in the first embodiment. Then, after completion of the recording process of S1211, the controller 80 performs the finishing process (S1212), and the processing returns to S1201.

In the seventeenth embodiment, when the particular time has come, the first ejection inspection, the subsequent post-inspection driving operation, and the subsequent second ejection inspection are performed. Then, depending on whether the first condition is satisfied, it is determined which of the first operation including the post-inspection driving operation and the second operation not including the post-inspection driving operation is to be performed after the second ejection inspection. Thus, the viscosity increase of the ink is efficiently suppressed in accordance with the results of the first and second ejection inspections.

Then, when the recording instruction signal is received, it is determined whether to perform the suction purge before the recording on the recording sheet S based on whether the third condition is satisfied. Thus, the purge is performed before the ink is ejected to the recording sheet S in a case where the necessity is high.

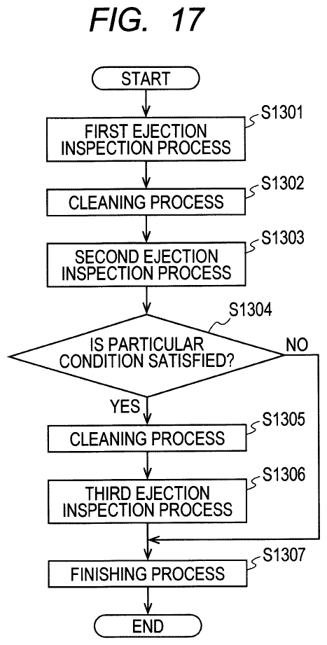

Next, an eighteenth embodiment of the present disclosure will be described. The eighteenth embodiment is also related to the printer 1 similar to the first embodiment. However, in the eighteenth embodiment, when performing inspection of whether each of the plurality of nozzles 10 of the inkjet head 4 is an abnormal nozzle, the controller 80 performs the processing in accordance with the flowchart of FIG. 17.

The flowchart of FIG. 17 will be described in detail. The controller 80 performs the first ejection inspection process (S1301). Subsequently, the controller 80 performs a cleaning process (S1302). In the cleaning process, the controller 80 performs a cleaning operation for resolving the abnormality of liquid ejection in the abnormal nozzle. For example, in the cleaning process, the controller 80 controls the carriage motor 86, the cap lifting mechanism 88, the suction pump 72, and so on to perform suction purge as the cleaning operation. Alternatively, for example, in the cleaning process, the controller 80 controls the plurality of driving elements 90 and so on to perform flushing for discharging ink from the abnormal nozzle as the cleaning operation. Alternatively, for example, in the cleaning process, the controller 80 controls the plurality of driving elements 90 and so on to perform a non-ejection driving operation of vibrating the ink in the abnormal nozzle as the cleaning operation.

Subsequently, the controller 80 performs the second ejection inspection process (S1303), and determines whether a particular condition is satisfied (S1304). The particular condition is a condition regarding the relationship between the result of the first ejection inspection and the result of the second ejection inspection. The particular condition is, for example, the same condition as the first condition in any one of the first to third embodiments. In a case where the particular condition is satisfied (S1304: YES), the controller 80 performs a cleaning process similar to S1302 (S1305), subsequently performs the third ejection inspection process (S1306), subsequently performs the finishing process (S1307), and the processing ends. In a case where the particular condition is not satisfied (S1304: NO), the controller 80 performs the finishing process (S1307), and the processing ends.

In the eighteenth embodiment, the second ejection inspection is performed after the cleaning operation is performed after the first ejection inspection, and it is determined whether to perform the first operation including the cleaning operation or the second operation different from the first operation after the second ejection inspection depending on whether the particular condition regarding the relationship between the result of the first ejection inspection and the result of the second ejection inspection is satisfied. Thus, the viscosity increase of the ink in the nozzles 10 is efficiently suppressed in accordance with the results of the first and second ejection inspections. For example, in a case where the effect of suppressing the viscosity increase by the cleaning operation after the first ejection inspection is high, the first operation including the cleaning operation is performed after the second ejection inspection, thereby further suppressing the viscosity increase. For example, in a case where the effect of suppressing the viscosity increase by the cleaning operation after the first ejection inspection is low, the second operation different from the first operation is performed after the second ejection inspection, thereby not repeating the cleaning operation having a low viscosity increase reduction effect.

While the present disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the present disclosure, and not limiting the present disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described present disclosure are provided below.

In the third and sixth embodiments, the first range and the second range in the first condition correspond to the purge level, but the present disclosure is not limited to this. The first range and the second range in the first condition may be set regardless of the purge level.

In the fourth to twelfth, fourteenth, and sixteenth embodiments, the ejection energy applied to the ink in the nozzle 10 is changed (differentiated) between the first post-inspection driving process and the second post-inspection driving process by changing one of the driving time of the driving element 90, the number of times of driving the driving element 90, the driving frequency of the driving element 90, and the driving voltage applied to the driving element 90 in the high-frequency ejection driving operation, or by changing the number of times of repetitions of the non-ejection driving operation, the low-frequency ejection driving operation, and the high-frequency ejection driving operation. In the fourteenth embodiment, the ejection energy applied to the ink in the nozzles 10 is changed between the first post-inspection driving process and the third post-inspection driving process by changing one of the driving time of the driving element 90, the number of times of driving of the driving element 90, the driving frequency of the driving element 90, and the driving voltage applied to the driving element 90 in the high-frequency ejection driving operation, or by changing the number of repetitions of the non-ejection driving operation, the low-frequency ejection driving operation, and the high-frequency ejection driving operation. However, the present disclosure is not limited to these.

For example, two or more of the driving time of the driving element 90, the number of times of driving of the driving element 90, the driving frequency of the driving element 90, and the driving voltage applied to the driving element 90 in the high-frequency ejection driving operation may be changed between the first post-inspection driving process and the second post-inspection driving process or between the first post-inspection driving process and the third post-inspection driving process.

Alternatively, at least one of the driving time of the driving element 90, the number of times of driving of the driving element 90, the driving frequency of the driving element 90, and the driving voltage applied to the driving element 90 in the high-frequency ejection driving operation may be changed, and also the number of times of repetition of the non-ejection driving operation, the low-frequency ejection driving operation, and the high-frequency ejection driving operation may be changed between the first post-inspection driving process and the second post-inspection driving process, or between the first post-inspection driving process and the third post-inspection driving process.

Alternatively, for example, at least one of the driving time of the driving element 90, the number of times of driving of the driving element 90, the driving frequency of the driving element 90, and the driving voltage applied to the driving element 90 in at least one of the non-ejection driving operation and the low-frequency ejection driving operation may be changed between the first post-inspection driving process and the second post-inspection driving process, or between the first post-inspection driving process and the third post-inspection driving process.

Alternatively, for example, at least one of the driving time of the driving element 90, the number of times of driving of the driving element 90, the driving frequency of the driving element 90, and the driving voltage applied to the driving element 90 may be changed in two or more driving operations among the non-ejection driving operation, the low-frequency ejection driving operation, and the high-frequency ejection driving operation between the first post-inspection driving process and the second post-inspection driving process, or between the first post-inspection driving process and the third post-inspection driving process.

Further, in at least one of the non-ejection driving operation, the low-frequency ejection driving operation, and the high-frequency ejection driving operation, a parameter other than the above-described parameters, such as the driving waveform of the driving element 90, may be changed between the first post-inspection driving process and the second post-inspection driving process, or between the first post-inspection driving process and the third post-inspection driving process.

In the first to seventeenth embodiments, in the post-inspection driving process, three types of driving operations, that is, the non-ejection driving operation, the low-frequency ejection driving operation, and the high-frequency ejection driving operation are performed, but the present disclosure is not limited to this.

For example, in the post-inspection driving process, two types of ejection driving operations, that is, the non-ejection driving operation and an ejection driving operation may be performed. The driving frequency of the driving element 90 in the ejection driving operation in this case may be the same as the driving frequency of the low-frequency ejection driving operation or the high-frequency ejection driving operation, or may be different from the driving frequency of the low-frequency ejection driving operation and from the driving frequency of the high-frequency ejection driving operation. Alternatively, in the post-inspection driving process, two types of driving operations, that is, the low-frequency ejection driving operation and the high-frequency ejection driving operation may be performed.

Alternatively, four or more types of driving operations may be performed in the post-inspection driving process. In this case, the four or more types of driving operations may include one type of non-ejection driving operation, may include two or more types of non-ejection driving operations in which the driving frequency of the driving element 90 is different, may include one type of ejection driving operation, or may include two or more types of ejection driving operations in which the driving frequency of the driving element 90 is different.

In the fourteenth embodiment, the first post-inspection driving process is performed in a case where the number of abnormal nozzles N1 is greater than or equal to the fourth number Nf and less than the sixth number Nh and where the number of abnormal nozzles N1 is greater than or equal to the seventh number Ni and less than the sixth number Nh, and the third post-inspection driving process is performed in a case where the number of abnormal nozzles N1 is greater than or equal to the fourth number Nf and less than the seventh number Ni. The present disclosure is not limited to this. For example, in a case where the number of abnormal nozzles N1 is greater than or equal to the fourth number Nf and less than the sixth number Nh, the first post-inspection driving process may be performed.

In the thirteenth and fourteenth embodiments, the purge process is performed in a case where the number of abnormal nozzles N1 is greater than or equal to the fifth number Ng, but the present disclosure is not limited to this. In a case where the number of abnormal nozzles N1 is greater than or equal to the fifth number Ng, the purge process and the subsequent third ejection inspection process may not be performed. In this case, for example, a message and so on prompting replacement of the inkjet head 4 may be displayed on the operation panel 69.

In the first to seventeenth embodiments, in the post-inspection driving process after the first ejection inspection, the non-ejection driving operation, the low-frequency ejection driving operation, and the high-frequency ejection driving operation are performed for the nozzle 10 for which the result of the first ejection inspection indicates that the nozzle is an abnormal nozzle, but the present disclosure is not limited to this. In the post-inspection driving process after the first ejection inspection, the non-ejection driving operation, the low-frequency ejection driving operation, and the high-frequency ejection driving operation may be performed for all the nozzles 10 of the inkjet head 4.

In the first to eighteenth embodiments, in the second ejection inspection, inspection of whether the nozzle 10 is an abnormal nozzle is performed for the nozzle 10 for which the result of the first ejection inspection indicates that the nozzle 10 is an abnormal nozzle. However, the present disclosure is not limited to this. In the second ejection inspection, all the nozzles 10 of the inkjet head 4 may be inspected to determine whether the nozzles are abnormal nozzles.

In the first to seventeenth embodiments, in the post-inspection driving process after the second ejection inspection, the non-ejection driving operation, the low-frequency ejection driving operation, and the high-frequency ejection driving operation are performed for the nozzle 10 for which the result of the second ejection inspection process indicates that the nozzle is an abnormal nozzle, but the present disclosure is not limited to this. In the post-inspection driving process after the second ejection inspection, the non-ejection driving operation, the low-frequency ejection driving operation, and the high-frequency ejection driving operation may be performed for all the nozzles 10 of the inkjet head 4.

In the first to eighteenth embodiments, in the third ejection inspection process, it is inspected whether the nozzle 10 is an abnormal nozzle for the nozzle 10 for which the result of the second ejection inspection process indicates that the nozzle 10 is an abnormal nozzle. However, the present disclosure is not limited to this. In the third ejection inspection process, the non-ejection driving operation, the low-frequency ejection driving operation, and the high-frequency ejection driving operation may be performed for all the nozzles 10 of the inkjet head 4.

In the first to seventeenth embodiments, in a case where the post-inspection driving process is performed after the second ejection inspection process, the third ejection inspection process is performed after the post-inspection driving process. In the eighteenth embodiment, in a case where the cleaning process is performed after the second ejection inspection process, the third ejection inspection process is performed after the cleaning process. However, the present disclosure is not limited to this. In these cases, the third ejection inspection process may not be performed, and the ejection inspection process may be performed when information on the result of the ejection inspection is required.

In the first to seventeenth embodiments, the first condition for determining whether to perform the first operation or the second operation after the second ejection inspection is not limited to the conditions described in the above examples, and may be another condition regarding the relationship between the result of the first ejection inspection and the result of the second ejection inspection. In the first to seventeenth embodiments, in a case where the post-inspection driving operation is performed after the second ejection inspection, the second condition for determining whether to perform the first post-inspection driving operation or the second post-inspection driving operation is not limited to the conditions described in the above examples, and may be another condition regarding the relationship between the result of the first ejection inspection and the result of the second ejection inspection. In the eighteenth embodiment, the particular condition for determining whether to perform the first operation or the second operation after the second ejection inspection is not limited to the condition described in the above example, and may be another condition regarding the relationship between the result of the first ejection inspection and the result of the second ejection inspection.

The first operation and the second operation are not limited to the operations described above. In the first to seventeenth embodiments, the first operation may be another operation including the post-inspection driving operation. In the eighteenth embodiment, the first operation may be another operation including the cleaning operation. In the first to eighteenth embodiments, the second operation may be an operation different from the first operation, which is different from the operation described above. In the first to seventeenth embodiments, the second operation may not include the post-inspection driving operation, or may include a post-inspection driving operation of a type different from the first operation. In the eighteenth embodiment, the second operation may not include the cleaning operation, or may include a cleaning operation of a type different from the first operation.

In the above examples, the printer 1 performs the suction purge as the purge, but the present disclosure is not limited to this. For example, a pressure pump that pressurizes the ink in the inkjet head 4 may be provided in a flow path and so on between the ink cartridge and the inkjet head 4. The pressure pump may be driven in a state where the plurality of nozzles 10 are covered with the cap 71, thereby performing a pressure purge for discharging the ink in the inkjet head 4. In this case, a combination of the cap 71 and the pressure pump is an example of “purge unit” of the present disclosure.

Both the suction purge by driving the suction pump 72 and the pressure purge by driving the pressure pump may be performed. In this case, a combination of the maintenance unit 8 and the pressure pump is an example of “purge unit” of the present disclosure.

In the above-described embodiments, whether a nozzle is an abnormal nozzle is inspected based on the signal output from the signal processing circuit 78 in accordance with a change in the voltage between the nozzle 10 (the inkjet head 4) and the electrode 76 arranged in the cap 71 when the inkjet head 4 is caused to perform the inspection driving operation. However, the present disclosure is not limited to this.

For example, instead of the electrode 76, an electrode extending in the vertical direction and facing the space below the nozzles 10 in a state where the carriage 2 is located at the maintenance position may be provided. The signal processing circuit 78 may output a signal corresponding to a change in the voltage of the above-mentioned electrode when the inspection driving operation is performed in a state where the carriage 2 is located at the maintenance position, and whether the nozzle is an abnormal nozzle may be inspected based on the signal.

Alternatively, for example, an optical sensor may be provided which directly detects the ink ejected from the nozzle 10 and outputs a signal corresponding to the detection result in a state where the carriage 2 is located at a particular position such as the maintenance position. Whether the nozzle is an abnormal nozzle may be inspected based on the signal output from the optical sensor.

Alternatively, for example, it may be inspected whether the nozzle is an abnormal nozzle in the same manner as described in U.S. Pat. No. 7,543,904 (corresponding to Japanese Patent No. 4929699). Specifically, a voltage detection circuit that detects a change in voltage when ink is ejected from the nozzle may be connected to a plate on which the nozzles of the inkjet head are formed. And, whether the nozzle is an abnormal nozzle may be inspected based on a signal output from the voltage detection circuit when an operation for ejecting ink from the nozzle is performed in a state where the carriage is moved to the inspection position.

Alternatively, for example, it may be inspected whether the nozzle is an abnormal nozzle in the same manner as described in U.S. Pat. No. 9,114,611 (corresponding to Japanese Patent No. 6231759). Specifically, a base board of the inkjet head may include a temperature detection element. After a heater is driven by applying a first applied voltage for ejecting ink, the heater may be driven by applying a second applied voltage so as not to eject ink, and whether the nozzle is abnormal may be inspected based on a change in temperature detected by the temperature detection element during a period from when the second applied voltage is applied until a particular time elapses.

Alternatively, for example, it may be inspected whether the nozzle is an abnormal nozzle in the same manner as described in Japanese Patent Application Publication No. 2004-284189, U.S. Patent Application Publication No. 2011/0285773 (corresponding to Japanese Patent Application Publication No. 2011-240563), and so on. Specifically, in a case where the inkjet head is configured to eject ink from nozzles by applying pressure to the ink in pressure chambers communicating with the nozzles by piezoelectric elements, a residual-vibration-type inspection device that detects residual vibration generated in the piezoelectric element due to a change in the pressure of the ink in the pressure chamber may be provided. It may be inspected whether the nozzle is an abnormal nozzle based on a vibration pattern of the residual vibration detected by the residual-vibration-type inspection device when the piezoelectric element is driven to eject the ink from the nozzle.

In the above-described examples, the present disclosure is applied to the printer including a so-called serial head which ejects ink from the plurality of nozzles while moving in the scanning direction together with the carriage, but the present disclosure is not limited to this. For example, the present disclosure may be applied to a printer including a so-called line head extending over the entire length of the recording sheet in the scanning direction.

In the above-described examples, the present disclosure is applied to the printer that performs recording on the recording sheet S by ejecting ink from nozzles, but the present disclosure is not limited to this. The present disclosure may also be applied to a recording apparatus that records an image on a recording medium other than recording paper, such as a T-shirt, a sheet for outdoor advertising, a case of a portable terminal such as a smartphone, a corrugated cardboard, or a resin member. The present disclosure may also be applied to a liquid ejection apparatus that ejects liquid other than ink droplets, for example, resin or metal in a liquid state.

What is claimed is:

1. A liquid ejection apparatus comprising:
a head including a plurality of nozzles and a plurality of driving elements, the plurality of driving elements being configured to apply ejection energy to liquid in the plurality of nozzles;
an ejection inspection circuit configured to perform ejection inspection of inspecting whether each of the plurality of nozzles is an abnormal nozzle having abnormality in ejection of liquid; and
a controller configured to:
control the ejection inspection circuit to perform a first ejection inspection;
after the first ejection inspection, control a driving element to perform a post-inspection driving operation including a plurality of types of driving operations, the plurality of types of driving operations having different driving frequencies for driving the driving element, the plurality of driving elements including the driving element;
after the post-inspection driving operation, control the ejection inspection circuit to perform a second ejection inspection;
in a case where a first condition is satisfied regarding a relationship between a result of the first ejection inspection and a result of the second ejection inspection, perform a first operation after the second ejection inspection, the first operation including the post-inspection driving operation; and
in a case where the first condition is not satisfied, perform a second operation after the second ejection inspection, the second operation being different from the first operation.

2. The liquid ejection apparatus according to claim 1, wherein the second operation does not include the post-inspection driving operation.

3. The liquid ejection apparatus according to claim 2, wherein the controller is configured to:
perform the post-inspection driving operation and the second ejection inspection after the first ejection inspection for a nozzle for which a result of the first ejection inspection indicates that the nozzle is the abnormal nozzle; and
perform the post-inspection driving operation in the first operation for a nozzle for which a result of the second ejection inspection indicates that the nozzle is the abnormal nozzle.

4. The liquid ejection apparatus according to claim 1, wherein the first condition is a condition that a decrease number is greater than or equal to a first number, the decrease number being a number of decrease from a number of abnormal nozzles indicated by a result of the first ejection inspection to a number of abnormal nozzles indicated by a result of the second ejection inspection.

5. The liquid ejection apparatus according to claim 1, wherein the first condition is a condition that a ratio of a decrease number to a number of abnormal nozzles indicated by a result of the first ejection inspection is greater than or equal to a first value, the decrease number being a number of decrease from the number of abnormal nozzles indicated by the result of the first ejection inspection to a number of abnormal nozzles indicated by a result of the second ejection inspection.

6. The liquid ejection apparatus according to claim 1, wherein the first condition is a condition that a number of abnormal nozzles indicated by a result of the first ejection inspection is within a first range and that a number of abnormal nozzles indicated by a result of the second ejection inspection is within a second range, the second range being a range of values smaller than values of the first range.

7. The liquid ejection apparatus according to claim 1, wherein the first operation includes a first post-inspection driving operation; and
wherein the second operation includes a second post-inspection driving operation in which at least one of the plurality of types of driving operations is performed with a driving condition different from a corresponding driving condition in the first post-inspection driving operation.

8. The liquid ejection apparatus according to claim 1, wherein the controller is configured to:
perform a first post-inspection driving operation after the first ejection inspection;
perform the second ejection inspection after the first post-inspection driving operation;
in a case where the first condition is not satisfied, perform the second operation not including the post-inspection driving operation after the second ejection inspection;
in a case where the first condition is satisfied and a second condition is satisfied, perform the first operation including the first post-inspection driving operation after the second ejection inspection, the second condition being different from the first condition, the second condition being related to a relationship between a result of the first ejection inspection and a result of the second ejection inspection; and
in a case where the first condition is satisfied and the second condition is not satisfied, perform the first operation including a second post-inspection driving operation after the second ejection inspection, the second post-inspection driving operation being a driving operation in which a driving condition of at least one of the plurality of types of driving operations is different from a corresponding driving condition in the first post-inspection driving operation.

9. The liquid ejection apparatus according to claim 8, wherein the first condition is a condition that a decrease number is greater than or equal to a first number, the decrease number being a number of decrease from a number of abnormal nozzles indicated by a result of the first ejection inspection to a number of abnormal nozzles indicated by a result of the second ejection inspection; and
wherein the second condition is a condition that the decrease number is greater than or equal to a second number which is greater than the first number.

10. The liquid ejection apparatus according to claim 8, wherein the first condition is a condition that a ratio of a decrease number to a number of abnormal nozzles indicated by a result of the first ejection inspection is greater than or equal to a first value, the decrease number being a number of decrease from the number of abnormal nozzles indicated by the result of the first ejection inspection to a number of abnormal nozzles indicated by a result of the second ejection inspection; and
wherein the second condition is a condition that the ratio is greater than or equal to a second value which is greater than the first value.

11. The liquid ejection apparatus according to claim 8, wherein the first condition is that a condition (A) or a condition (B) is satisfied, the condition (A) being that a number of abnormal nozzles indicated by a result of the first ejection inspection is a number within a first range and a number of abnormal nozzles indicated by a result of the second ejection inspection is a number within a second range, the second range being a range of values smaller than values of the first range, the condition (B) being that both the number of abnormal nozzles indicated by the result of the first ejection inspection and the number of abnormal nozzles indicated by the result of the second ejection inspection are numbers within the first range and that a decrease number is greater than or equal to a number determined based on the first range, the decrease number being a number of decrease from a number of abnormal nozzles indicated by a result of the first ejection inspection to a number of abnormal nozzles indicated by a result of the second ejection inspection; and
wherein the second condition is the condition (A).

12. The liquid ejection apparatus according to claim 6, further comprising:
a purge unit configured to perform purge of discharging liquid from the plurality of nozzles; and
a memory,
wherein the controller is configured to:
store, in the memory, information regarding the abnormal nozzle in the ejection inspection performed last;
control the purge unit to perform purge with a first setting in a case where the information indicates that the number of abnormal nozzles is a number within the first range; and
control the purge unit to perform purge with a second setting in a case where the information indicates that the number of abnormal nozzles is a number within the second range, the second setting being different from the first setting.

13. The liquid ejection apparatus according to claim 1, wherein the controller is configured to:
in a case where a number of abnormal nozzles indicated by a result of the first ejection inspection is greater than or equal to a first threshold and less than a second threshold, perform the post-inspection driving operation after the first ejection inspection; and
in a case where the number of abnormal nozzles indicated by the result of the first ejection inspection is less than the first threshold, or is greater than or equal to the second threshold, not perform the post-inspection driving operation after the first ejection inspection.

14. The liquid ejection apparatus according to claim 13, further comprising:
a purge unit configured to perform purge of discharging liquid from the plurality of nozzles,
wherein the controller is configured to:
in a case where the number of abnormal nozzles indicated by the result of the first ejection inspection is greater than or equal to the second threshold, control the purge unit to perform the purge after the first ejection inspection.

15. The liquid ejection apparatus according to claim 13, wherein the controller is configured to:
in a case where the number of abnormal nozzles indicated by the result of the first ejection inspection is greater than or equal to the first threshold and less than a third threshold, perform a first post-inspection driving operation after the first ejection inspection, the third threshold being between the first threshold and the second threshold; and
in a case where the number of abnormal nozzles indicated by the result of the first ejection inspection is greater than or equal to the third threshold and less than the second threshold, perform a second post-inspection driving operation after the first ejection inspection, the second post-inspection driving operation being a driving operation in which a driving condition in at least one of the plurality of types of driving operations is different from a corresponding driving condition in the first post-inspection driving operation, ejection energy applied to liquid in each of the plurality of nozzles in the second post-inspection driving operation being greater than ejection energy applied to liquid in each of the plurality of nozzles in the first post-inspection driving operation.

16. The liquid ejection apparatus according to claim 1, wherein the controller is configured to:
in a case where a number of abnormal nozzles indicated by a result of the first ejection inspection is less than a first threshold,
perform the post-inspection driving operation after the first ejection inspection;
perform the second ejection inspection after the post-inspection driving operation; and
not perform the post-inspection driving operation after the second ejection inspection, regardless of a result of the second ejection inspection.

17. The liquid ejection apparatus according to claim 7, wherein, in the second post-inspection driving operation, a driving time of the driving element in at least one of the plurality of types of driving operations is longer than a driving time of the driving element in the first post-inspection driving operation.

18. The liquid ejection apparatus according to claim 7, wherein, in the second post-inspection driving operation, a driving frequency of the driving element in at least one of the plurality of types of driving operations is higher than a driving frequency of the driving element in the first post-inspection driving operation.

19. The liquid ejection apparatus according to claim 7, wherein, in the second post-inspection driving operation, a number of times of driving the driving element in at least one of the plurality of types of driving operations is greater than a number of times of driving the driving element in the first post-inspection driving operation.

20. The liquid ejection apparatus according to claim 7, wherein, as a higher driving voltage is applied to the driving element, the driving element applies greater ejection energy to liquid in a nozzle corresponding to the driving element; and
wherein, in the second post-inspection driving operation, a driving voltage applied to the driving element in at least one of the plurality of types of driving operations is higher than a driving voltage applied to the driving element in the first post-inspection driving operation.

21. The liquid ejection apparatus according to claim 7, wherein the post-inspection driving operation is an operation of repeating the plurality of types of driving operations; and
wherein, in the second post-inspection driving operation, a number of times of repeating the plurality of types of driving operations is greater than a number of times of repeating the plurality of types of driving operations in the first post-inspection driving operation.

22. The liquid ejection apparatus according to claim 1, wherein the plurality of types of driving operations include:
a first driving operation of driving the driving element to apply, to liquid in a nozzle, ejection energy smaller than ejection energy required for ejecting liquid from the nozzle; and
a second driving operation of driving the driving element to apply, to liquid in the nozzle, ejection energy required for ejecting liquid from the nozzle.

23. The liquid ejection apparatus according to claim 22, wherein the plurality of types of driving operations include a third driving operation different from the first driving operation and the second driving operation.

24. The liquid ejection apparatus according to claim 1, further comprising:
a purge unit configured to perform purge of discharging liquid from the plurality of nozzles,
wherein the controller is configured to:
at a particular time, control the ejection inspection circuit to perform the first ejection inspection;
after the first ejection inspection, perform the post-inspection driving operation;
after the post-inspection driving operation, control the ejection inspection circuit to perform the second ejection inspection;
in a case where the first condition is satisfied, perform the first operation after the second ejection inspection;
in a case where the first condition is not satisfied, perform the second operation after the second ejection inspection; and
after performing the first operation or the second operation, in response to receiving an ejection instruction signal instructing ejection of liquid to a medium,
in a case where a purge condition regarding a result of the second ejection inspection is satisfied, control the purge unit to perform the purge and then drive the driving element to eject liquid from a nozzle corresponding to the driving element toward the medium; and
in a case where the purge condition is not satisfied, drive the driving element to eject liquid from the nozzle toward the medium, without performing the purge by the purge unit.

25. A liquid ejection apparatus comprising:
a head including a plurality of nozzles and a plurality of driving elements, the plurality of driving elements being configured to apply ejection energy to liquid in the plurality of nozzles;
an ejection inspection circuit configured to perform ejection inspection of inspecting whether each of the plurality of nozzles is an abnormal nozzle having abnormality in ejection of liquid; and
a controller configured to:
control the ejection inspection circuit to perform a first ejection inspection;
after the first ejection inspection, perform a cleaning operation of discharging liquid from the abnormal nozzle;
after the cleaning operation, control the ejection inspection circuit to perform a second ejection inspection;
in a case where a particular condition is satisfied regarding a relationship between a result of the first ejection inspection and a result of the second ejection inspection, perform a first operation after the second ejection inspection, the first operation including the cleaning operation; and
in a case where the particular condition is not satisfied, perform a second operation after the second ejection inspection, the second operation being different from the first operation.
